(19) United States
(12) Patent Application Publication
(10) Pub. No.: US 2026/0229614 A1
(43) Pub. Date: Aug. 6, 2026

(54) SECONDARY BATTERY AND METHOD OF MANUFACTURING SECONDARY BATTERY

(71) Applicant: MURATA MANUFACTURING CO., LTD., Kyoto (JP)

(72) Inventors: Aika OCHI, Kyoto (JP); Takumi HIASA, Kyoto (JP); Kazuaki FUKUSHIMA, Kyoto (JP)

(21) Appl. No.: 19/576,603

(22) Filed: Mar. 24, 2026

Related U.S. Application Data
(63) Continuation of application No. PCT/JP2024/033943, filed on Sep. 24, 2024.

(30) Foreign Application Priority Data
Sep. 29, 2023 (JP) 2023-169635

(51) Int. Cl. H01M 10/28; H01M 4/02; H01M 4/66; H01M 50/121; H01M 50/193; H01M 50/474; H01M 50/486

(52) U.S. Cl. CPC H01M 10/28; H01M 4/662; H01M 4/669; H01M 50/121; H01M 50/193; H01M 50/474; H01M 50/486; H01M 2004/027; H01M 2004/028

(57) ABSTRACT

A secondary battery is provided and includes a partition, an outer package member, a positive electrode aqueous electrolytic solution, a negative electrode aqueous electrolytic solution, a positive electrode, and a negative electrode. The partition allows an alkali metal ion to pass therethrough. The outer package member has a positive electrode space and a negative electrode space inside the outer package member. The positive electrode space and the negative electrode space are separated from each other with the partition interposed therebetween. The positive electrode aqueous electrolytic solution is contained in the positive electrode space. The negative electrode aqueous electrolytic solution is contained in the negative electrode space. The positive electrode is immersed in the positive electrode aqueous electrolytic solution and which the alkali metal ion is to be inserted into and extracted from. The negative electrode is immersed in the negative electrode aqueous electrolytic solution and which the alkali metal ion is to be inserted into and extracted from. The partition includes an outer edge part and a body part. The outer edge part is adjacent to the outer package member. The body part is positioned on an inner side relative to the outer edge part. The body part includes a cation exchange membrane. All or a part of the outer edge part includes a first polymer compound. The first polymer compound includes at least one of a hydroxyl group, a primary amino group, a secondary amino group, a primary amide group, a secondary amide group, or a carboxyl group.

### CROSS REFERENCE TO RELATED APPLICATIONS

The present application is a continuation of International Patent Application No. PCT/JP2024/033943, filed on Sep. 24, 2024, which claims priority to Japanese Patent Application No. 2023-169635, filed on Sep. 29, 2023, the entire contents of which are incorporated herein by reference.

### BACKGROUND

The present technology relates to a secondary battery and a method of manufacturing the secondary battery.

Various kinds of electronic equipment, including mobile phones, have been widely used. Such widespread use has promoted development of a secondary battery as a power source that is smaller in size and lighter in weight and allows for a higher energy density. In particular, a secondary battery including an aqueous electrolytic solution is being developed. A configuration of the secondary battery has been considered in various ways.

Specifically, an electrochemical device (a fuel cell) includes: an electrolyte membrane; a resin that adheres to the electrolyte membrane; and a resin that adheres to a metal. A secondary battery includes: a positive electrode and an aqueous electrolytic solution that are contained in a first space; a partition that allows a metal ion to pass therethrough; and a negative electrode and an aqueous electrolytic solution that are contained in a second space. A metal-air cell includes: a cell case; and a positive electrode, a negative electrode, and a separator housed in the cell case.

### SUMMARY

The present technology relates to a secondary battery and a method of manufacturing the secondary battery.

Although consideration has been given in various ways regarding a configuration of a secondary battery including an aqueous electrolytic solution, an operation characteristic of the secondary battery is not sufficient yet. Accordingly, there is room for improvement in terms of the operation characteristic. In this case, it is important not only to improve the operation characteristic, but also to establish a method of manufacturing the secondary battery whose operation characteristic is improved.

It is desirable to provide a secondary battery and a method of manufacturing the secondary battery each of which makes it possible to achieve a superior operation characteristic.

A secondary battery according to an embodiment of the present technology includes a partition, an outer package member, a positive electrode aqueous electrolytic solution, a negative electrode aqueous electrolytic solution, a positive electrode, and a negative electrode. The partition allows an alkali metal ion to pass through the partition. The outer package member has a positive electrode space and a negative electrode space inside the outer package member. The positive electrode space and the negative electrode space are separated from each other with the partition interposed between the positive electrode space and the negative electrode space. The positive electrode aqueous electrolytic solution is contained in the positive electrode space. The negative electrode aqueous electrolytic solution is contained in the negative electrode space. The positive electrode is immersed in the positive electrode aqueous electrolytic solution and which the alkali metal ion is to be inserted into and extracted from. The negative electrode is immersed in the negative electrode aqueous electrolytic solution and which the alkali metal ion is to be inserted into and extracted from. The partition includes an outer edge part and a body part. The outer edge part is adjacent to the outer package member. The body part is positioned on an inner side relative to the outer edge part. The body part includes a cation exchange membrane. All or a part of the outer edge part includes a first polymer compound. The first polymer compound includes at least one of a hydroxyl group, a carboxyl group, a carboxylic acid anhydride, a carboxylic acid ester, or a basic functional group including nitrogen.

A method of manufacturing a secondary battery according to an embodiment of the present technology includes, in a process of manufacturing the above-described secondary battery of an embodiment of the present technology: thermal-fusion-bonding all or a part of the outer edge part and the body part to each other; and forming the partition by the thermal-fusion-bonding.

According to the secondary battery of an embodiment of the present technology: the positive electrode space and the negative electrode space are separated from each other with the partition interposed therebetween; the partition includes the outer edge part and the body part; the body part includes the cation exchange membrane; all or a part of the outer edge part includes the first polymer compound; and the first polymer compound includes at least one of a hydroxyl group, a primary amino group, a secondary amino group, a primary amide group, a secondary amide group, or a carboxyl group. This makes it possible to achieve a superior operation characteristic.

According to the method of manufacturing the secondary battery of an embodiment of the present technology, in the process of manufacturing the above-described secondary battery of an embodiment of the present technology, all or a part of the outer edge part and the body part are thermal-fusion-bonded to each other to thereby form the partition. This makes it possible to achieve a secondary battery having a superior operation characteristic.

Note that effects of the present technology are not necessarily limited to those described herein and may include any of a series of effects including described below in relation to the present technology.

### BRIEF DESCRIPTION OF THE FIGURES

FIG. 1 is a sectional diagram illustrating a configuration of a secondary battery according to an embodiment of the present technology.

FIG. 2 is a sectional diagram along a line A-A of the secondary battery illustrated in FIG. 1.

FIG. 3 is a sectional diagram illustrating a configuration of a secondary battery according to an embodiment.

FIG. 4 is a sectional diagram illustrating a configuration of a secondary battery according to an embodiment.

FIG. 5 is a sectional diagram illustrating a configuration of a secondary battery according to Modification example 5.

FIG. 6 is a sectional diagram illustrating a configuration of a secondary battery according to according to an embodiment.

FIG. 7 is a sectional diagram illustrating a configuration of a secondary battery according to an embodiment.

FIG. 8 is a sectional diagram illustrating a configuration of a secondary battery according to an embodiment.

### DETAILED DESCRIPTION

The present technology is described below in further detail including with reference to the drawings according to an embodiment.

A description is given first of a secondary battery according to an embodiment of the present technology.

Note that a method of manufacturing a secondary battery according to an embodiment of the present technology is a method of manufacturing the secondary battery to be described here. Accordingly, the method of manufacturing the secondary battery according to the embodiment of the present technology will be described together below.

The secondary battery to be described here is a secondary battery utilizing insertion and extraction of an alkali metal ion. The secondary battery includes a positive electrode, a negative electrode, and an aqueous electrolytic solution. The aqueous electrolytic solution is a liquid electrolyte including an aqueous solvent. The secondary battery utilizes insertion and extraction of the alkali metal ion to allow charging and discharging reactions to proceed, thereby obtaining a battery capacity.

The alkali metal ion is not particularly limited in kind. Specific examples of the alkali metal ion include a lithium ion, a sodium ion, and a potassium ion. One reason for this is that the charging and discharging reactions proceed stably while a high voltage is secured.

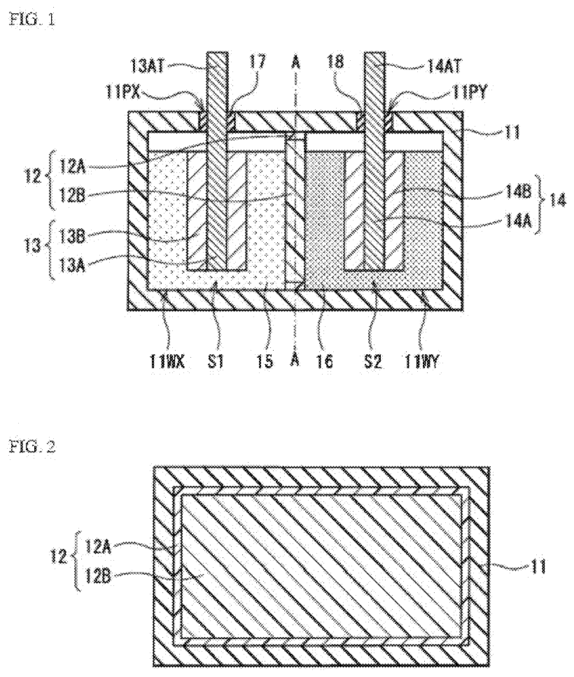

FIG. 1 illustrates a sectional configuration of a secondary battery. FIG. 2 illustrates a sectional configuration along a line A-A of the secondary battery illustrated in FIG. 1.

As illustrated in FIGS. 1 and 2, the secondary battery includes an outer package member 11, a partition 12, a positive electrode 13, a negative electrode 14, a positive electrode aqueous electrolytic solution 15, a negative electrode aqueous electrolytic solution 16, a positive electrode sealing member 17, and a negative electrode sealing member 18. In FIG. 1, the positive electrode aqueous electrolytic solution 15 is lightly shaded, and the negative electrode aqueous electrolytic solution 16 is darkly shaded.

Each of the positive electrode aqueous electrolytic solution 15 and the negative electrode aqueous electrolytic solution 16 is the aqueous electrolytic solution described above, and thus includes an aqueous solvent. The aqueous electrolytic solution includes an ionic material ionizable in the aqueous solvent. The ionic material is dissolved or dispersed in the aqueous solvent. Details of each of the positive electrode aqueous electrolytic solution 15 and the negative electrode aqueous electrolytic solution 16 will be described later.

The outer package member 11 contains a series of components including, without limitation, the partition 12, the positive electrode 13, the negative electrode 14, the positive electrode aqueous electrolytic solution 15, and the negative electrode aqueous electrolytic solution 16, and has an interior space for containing the series of components. The interior space is divided into two spaces with the partition 12 interposed therebetween. The outer package member 11 thus has therein a positive electrode space S1 and a negative electrode space S2 that are separated from each other with the partition 12 interposed therebetween.

The outer package member 11 preferably includes a positive electrode outlet 11PX that does not communicate with the negative electrode space S2 but communicates with the positive electrode space S1. One reason for this is that a positive electrode current collector 13A, e.g., a coupling terminal part 13AT, to be described later is led to an outside of the outer package member 11 through the positive electrode outlet 11PX, which makes it possible for the secondary battery to be coupled to external equipment via the coupling terminal part 13AT. The external equipment is operable by using the secondary battery as a power source, and is not particularly limited in kind.

The outer package member 11 preferably includes a negative electrode outlet 11PY that does not communicate with the positive electrode space S1 but communicates with the negative electrode space S2. One reason for this is that a negative electrode current collector 14A, e.g., a coupling terminal part 14AT, to be described later is led to the outside of the outer package member 11 through the negative electrode outlet 11PY, which makes it possible for the secondary battery to be coupled to external equipment via the coupling terminal part 14AT.

Note that the outer package member 11 may be a member having softness or flexibility, or a member having rigidity. Here, the outer package member 11 is preferably a polymer film having softness and flexibility, and thus preferably includes any one or more of second polymer compounds. Accordingly, the outer package member has a pouch-shaped structure that has the positive electrode space S1 and the negative electrode space S2 therein.

The second polymer compound includes any one or more of polyethylene, polypropylene, polyethylene terephthalate, polytetrafluoroethylene, or polyvinyl chloride. One reason for this is that this makes it possible for the outer package member 11 to achieve a high hermetically closed property.

Here, the outer package member 11 is preferably sufficiently hydrophilic to each of the positive electrode aqueous electrolytic solution 15 and the negative electrode aqueous electrolytic solution 16.

Specifically, the outer package member 11 has a positive electrode inner wall surface 11WX inside the positive electrode space S1, and the positive electrode inner wall surface 11WX is in contact with the positive electrode aqueous electrolytic solution 15 contained in the positive electrode space S1.

A contact angle of the positive electrode aqueous electrolytic solution 15 with respect to the positive electrode inner wall surface 11WX is not particularly limited, and is preferably less than or equal to 150° in particular. One reason for this is that this secures wettability of the positive electrode inner wall surface 11WX with respect to the positive electrode aqueous electrolytic solution 15, which makes it easier for the charging and discharging reactions to proceed sufficiently upon charging and discharging. This allows for an improvement in a battery characteristic such as charge and discharge efficiency.

The outer package member 11 also has a negative electrode inner wall surface 11WY inside the negative electrode space S2, and the negative electrode inner wall surface 11WY is in contact with the negative electrode aqueous electrolytic solution 16 contained in the negative electrode space S2.

A contact angle of the negative electrode aqueous electrolytic solution 16 with respect to the negative electrode inner wall surface 11WY is not particularly limited, and is preferably less than or equal to 150° in particular. One reason for this is that this secures wettability of the negative electrode inner wall surface 11WY with respect to the negative electrode aqueous electrolytic solution 16, which makes it possible to achieve an advantage similar to that when the wettability of the positive electrode inner wall surface 11WX with respect to the positive electrode aqueous electrolytic solution 15 is secured.

The contact angle of the positive electrode aqueous electrolytic solution 15 with respect to the positive electrode inner wall surface 11WX is adjustable by subjecting the positive electrode inner wall surface 11WX to a surface treatment. The contact angle of the negative electrode aqueous electrolytic solution 16 with respect to the negative electrode inner wall surface 11WY is also adjustable by subjecting the negative electrode inner wall surface 11WY to a surface treatment. The surface treatment is not limited in kind as long as it is a method of improving the wettability of each of the positive electrode inner wall surface 11WX and the negative electrode inner wall surface 11WY, and specific examples thereof include a plasma treatment.

The contact angle is measurable by a sessile drop method.

The partition 12 is disposed between the positive electrode space S1 and the negative electrode space S2 inside the outer package member 11, and separates the positive electrode space S1 and the negative electrode space S2 from each other. Thus, the positive electrode aqueous electrolytic solution 15 contained in the positive electrode space S1 and the negative electrode aqueous electrolytic solution 16 contained in the negative electrode space S2 are so separated from each other as not to be mixed with each other. The positive electrode aqueous electrolytic solution 15 and the negative electrode aqueous electrolytic solution 16 are opposed to each other with the partition 12 interposed therebetween.

The partition 12 does not allow an anion to pass therethrough and allows a substance such as the alkali metal ion (a cation) other than the anion, which is to be inserted into and extracted from each of the positive electrode 13 and the negative electrode 14, to pass therethrough, between the positive electrode aqueous electrolytic solution 15 and the negative electrode aqueous electrolytic solution 16. One reason for this is that the alkali metal ion becomes movable between the positive electrode 13 and the negative electrode 14 while mixing of the positive electrode aqueous electrolytic solution 15 and the negative electrode aqueous electrolytic solution 16 with each other is prevented. Thus, the partition 12 allows the alkali metal ion to pass therethrough from the positive electrode aqueous electrolytic solution 15 to the negative electrode aqueous electrolytic solution 16, and also allows the alkali metal ion to pass therethrough from the negative electrode aqueous electrolytic solution 16 to the positive electrode aqueous electrolytic solution 15.

In particular, the partition 12 includes an outer edge part 12A and a body part 12B.

The outer edge part 12A is an outer part of the partition 12, and more specifically, is a part adjacent to the outer package member 11. The outer edge part 12A extends along an entire part, of an inner surface of the outer package member 11, that is adjacent to the partition 12 in order to separate the positive electrode space S1 and the negative electrode space S2 from each other, and thus has a frame shaped structure, as illustrated in FIG. 2.

Here, all of the outer edge part 12A is rigidly joined to the body part 12B and, more specifically, chemically bonded to the body part 12B. All of the outer edge part 12A thus includes any one or more of first polymer compounds that are chemically bondable to the body part 12B. The first polymer compound includes any one or more of specific functional groups to allow the chemical bonding of the outer edge part 12A to the body part 12B. The first polymer compound may include a functional group that is the same as a functional group included in a cation exchange membrane included in the body part 12 to be described later; however, the first polymer compound includes at least one functional group that is different from the functional group included in the cation exchange membrane.

The functional group is a hydroxyl group, a carboxyl group, a carboxylic acid anhydride, a carboxylic acid ester, or a basic functional group including nitrogen, and specific examples thereof include a hydroxyl group (—OH), a primary amino group (—NHR), a secondary amino group (—NR₂), a primary amide group (—C(═O)—NHR), a secondary amide group (—C(═O)—NR₂), and a carboxyl group (—C(═O)—OH), where R is either an alkyl group or an alkylene group, and each of the alkyl group and the alkylene group is not particularly limited in kind. Specific examples of the functional group may include a series of divalent groups in each of which hydrogen is removed from corresponding one of the above-described series of monovalent groups, and specific examples thereof include an ether group (—OR), a carboxylic acid ester group (—C(═O)—OR), and a carboxylic acid anhydride (—C(═O)—O—C(═O)—R).

In particular, the functional group is preferably the hydroxyl group (—OH), the primary amino group (—NHR), the secondary amino group (—NR₂), the primary amide group (—C(═O)—NHR), the secondary amide group (—C(═O)—NR₂), or the carboxyl group (—C(═O)—OH), for example. One reason for this is that such a functional group has high chemical reactivity, which allows for more rigid joining to the body part 12B as will be described later.

To confirm that the outer edge part 12A includes any one or more of the series of functional groups described above, the outer edge part 12A may be analyzed by any one or more of analysis methods including, without limitation, Fourier transform infrared spectroscopy (FT-IR). In this case, the secondary battery is disassembled to thereby take out the partition 12, following which a peeled surface of the outer edge part 12A peeled off from the body part 12B is analyzed.

One reason why the first polymer compound includes any one or more of the above-described series of functional groups is that each of the functional groups has a high affinity with the body part 12B. This secures a chemical bonding strength of the outer edge part 12A to the body part 12B. The outer edge part 12A is thus rigidly joined to the body part 12B as described above. As a result, the outer edge part 12A is rigidly fixed to the body part 12B, which secures a liquid sealing property inside the outer package member 11.

This prevents each of the positive electrode aqueous electrolytic solution 15 and the negative electrode aqueous electrolytic solution 16 from leaking easily from the outer package member 11, and also prevents the positive electrode aqueous electrolytic solution 15 and the negative electrode aqueous electrolytic solution 16 from mixing with each other. In this case, in particular, mixing of the positive electrode aqueous electrolytic solution 15 and the negative electrode aqueous electrolytic solution 16 is sufficiently suppressed with use of the partition 12, which makes it possible to stably achieve the secondary battery including two kinds of aqueous electrolytic solutions, i.e., the positive electrode aqueous electrolytic solution 15 and the negative electrode aqueous electrolytic solution 16.

The first polymer compound includes a skeleton into which any one or more of the series of functional groups described above are introduced. The skeleton is not particularly limited in kind as long as the skeleton is a hydrocarbon group. The hydrocarbon group may be an aliphatic hydrocarbon group or an aromatic hydrocarbon group, and is preferably an aliphatic hydrocarbon group in particular. One reason for this is that this makes it possible to easily form the first polymer compound.

The first polymer compound is not particularly limited in kind as long as the first polymer compound includes any one or more of the series of functional groups described above. Specific examples of the first polymer compound include nylon, polyvinyl alcohol, and an ethylene-vinyl alcohol copolymer. One reason for this is that the chemical bonding strength of the outer edge part 12A to the body part 12B sufficiently improves.

A method of bonding the outer edge part 12A to the body part 12B is not particularly limited. In particular, the outer edge part 12A is preferably thermal-fusion-bonded to the body part 12B. One reason for this is that the chemical bonding strength of the outer edge part 12A to the body part 12B sufficiently improves. The thermal fusion bonding is not particularly limited as long as it is a method of coupling two or more polymer compounds to each other by using heat. For example, the thermal fusion bonding described herein includes a series of heat treatment methods including, without limitation, thermal welding, and the description herein applies also to the following.

Note that the outer edge part 12A is also rigidly joined to the outer package member 11 and, more specifically, also chemically bonded to the outer package member 11. One reason for this is that the material (the first polymer compound) included in the outer edge part 12A is compatible with the outer package member 11 (the second polymer compound), and thus, the first polymer compound and the second polymer compound have a high affinity with each other. This secures the chemical bonding strength between the outer package member 11 and the outer edge part 12A. The outer package member 11 and the outer edge part 12A are thus rigidly joined to each other. As a result, the outer package member 11 and the outer edge part 12A are rigidly fixed to each other, which secures the liquid sealing property inside the outer package member 11.

Details of a method of bonding the outer edge part 12A to the outer package member 11 are similar to the details of the method of bonding the outer edge part 12A to the body part 12B described above.

This prevents, as described above, the easy occurrence of the leakage and the mixing of the positive electrode aqueous electrolytic solution 15 and the negative electrode aqueous electrolytic solution 16, which makes it possible to stably achieve the secondary battery including two kinds of aqueous electrolytic solutions, i.e., the positive electrode aqueous electrolytic solution 15 and the negative electrode aqueous electrolytic solution 16.

The body part 12B is an inner part of the partition 12, and more specifically, is a part positioned on an inner side relative to the outer edge part 12A. The body part 12B includes a functional film having a property of allowing a substance such as the alkali metal ion to pass therethrough, and more specifically, includes a cation exchange membrane. One reason for this is that this makes it easier for an appropriate amount of aqueous solvent within the aqueous solvent included in the positive electrode aqueous electrolytic solution 15 to permeate into the partition 12. Another reason for this is that this makes it easier for an appropriate amount of aqueous solvent within the aqueous solvent included in the negative electrode aqueous electrolytic solution 16 to permeate into the partition 12. This allows for an improvement in ion conductivity inside the partition 12.

This cation exchange membrane is a porous film having permeability to a substance such as the alkali metal ion, and is a polymer membrane having what is called an anionic group as described below.

The cation exchange membrane includes anionic groups (—X⁻), and the anionic groups are neutralized by cations including any one or more of ions including, without limitation, hydrogen ions (H⁺) and metal ions (Mⁿ⁺), where n is an integer of 1 or greater. Specific examples of the metal ion include a lithium ion, a sodium ion, and a potassium ion. Thus, the cation exchange membrane includes ion exchange groups (e.g., —X⁻H⁺ and —X⁻M⁺).

The anionic groups are not particularly limited in kind. For example, the anionic groups include a sulfonic acid ion group (—S(═O)₂—O⁻), a carboxylic acid ion group (—C(═O)—O⁻), or both. Thus, the ion exchange groups are not particularly limited in kind, and specific examples thereof include a sulfonic acid group (—S(═O)₂—OH⁺), a carboxyl group (—C(═O)—O⁻H⁺), a sulfonic acid metal complex (—S(═O)₂—O⁻M⁺), and a carboxylic acid metal complex (—C(═O)—O⁻M⁺). The sulfonic acid metal complex is what is called a sulfonic acid metal salt group, and the carboxylic acid metal complex is what is called a carboxylic acid metal salt group. Needless to say, the anionic groups may also include a group other than the sulfonic acid ion group and the carboxylic acid ion group.

To identify the kind of the anionic group, the body part 12B may be analyzed by any one or more of analysis methods including, without limitation, FT-IR. In this case, the secondary battery is disassembled to thereby take out the partition 12, following which a peeled surface of the body part 12B peeled off from the outer edge part 12A is analyzed.

A skeleton into which the ion exchange groups are introduced is not particularly limited in kind as long as the skeleton is a polymer compound to which the ion exchange groups are bondable. Specific examples of the polymer compound to be the skeleton include perfluorohydrocarbon, a polymer compound in which monomers each having an ethylene-based unsaturated double bond are polymerized, polysulfone, polyphenylene sulfide, polyether ketone, polyether ether ketone, polyether imide, polyphenylene oxide, polyether sulfone, polybenzimidazole, a polystyrene-poly(ethylene-butylene)-polystyrene triblock copolymer, a polystyrene-poly(ethylene-propylene)-polystyrene triblock copolymer, a styrene-divinylbenzene copolymer, and a styrene-based elastomer. Examples of the polymer compound in which monomers each having the ethylene-based unsaturated double bond are polymerized include vinyl-based, styrene-based, or acrylic-based polymer compounds. Examples of the styrene-based elastomer include a polystyrene-polyisoprene block copolymer and a hydrogenated compound of the polystyrene-polyisoprene block copolymer.

In particular, the anionic groups preferably include the sulfonic acid ion group, the carboxylic acid ion group, or both. One reason for this is that the outer edge part 12A has a high affinity with the anionic groups. This secures a chemical bonding strength of the body part 12B to the outer edge part 12A. The body part 12B is thus rigidly joined to the outer edge part 12A as described above. As a result, the body part 12B is rigidly fixed to the outer edge part 12A, which secures the liquid sealing property inside the outer package member 11.

This prevents, as described above, the easy occurrence of the leakage and the mixing of the positive electrode aqueous electrolytic solution 15 and the negative electrode aqueous electrolytic solution 16, which makes it possible to stably achieve the secondary battery including two kinds of aqueous electrolytic solutions, i.e., the positive electrode aqueous electrolytic solution 15 and the negative electrode aqueous electrolytic solution 16.

The outer edge part 12A and the body part 12B are thus rigidly fixed to each other, and are accordingly preferably integrated with each other. One reason for this is that this allows for a sufficient improvement in the liquid sealing property owing to the partition 12, inside the outer package member 11.

Here, the partition 12 is so disposed inside the outer package member 11 as not to be exposed from the outer package member 11. Further, the body part 12B is contained inside the outer package member 11 together with the outer edge part 12A, and is disposed on the inner side relative to the outer edge part 12A inside the outer package member 11. As a result, the body part 12B is unexposed to the outside of the outer package member 11. One reason for this is that, unlike the case where the body part 12B is exposed to the outside of the outer package member 11, this prevents easy leakage of each of the positive electrode aqueous electrolytic solution 15 and the negative electrode aqueous electrolytic solution 16 from the body part 12B to the outside of the outer package member 11.

The positive electrode 13 allows the alkali metal ion, which passes through the partition 12, to be inserted thereinto and extracted therefrom. The positive electrode 13 is contained in the positive electrode space S1, and more specifically, is immersed in the positive electrode aqueous electrolytic solution 15 contained in the positive electrode space S1.

Specifically, the positive electrode 13 includes the positive electrode current collector 13A and a positive electrode active material layer 13B.

The positive electrode current collector 13A is an electrically conductive member that supports the positive electrode active material layer 13B. The positive electrode current collector 13A includes any one or more of first metal materials. Specific examples of the first metal material include titanium, aluminum, nickel, and alloys of two or more of these metals.

Note that the positive electrode current collector 13A is preferably insoluble or sparingly soluble in and resistant to corrosion by the positive electrode aqueous electrolytic solution 15, and has low reactivity to a positive electrode active material to be described later. One reason for this is that this suppresses degradation of the positive electrode current collector 13A upon operation of the secondary battery.

Here, the positive electrode current collector 13A includes the coupling terminal part 13AT. The coupling terminal part 13AT is an end part, of the positive electrode current collector 13A, on which no positive electrode active material layer 13B is provided. The coupling terminal part 13AT is led to the outside of the outer package member 11 through the positive electrode outlet 11PX. As described above, one reason for this is that this makes it possible for the secondary battery to be coupled to external equipment via the coupling terminal part 13AT.

Note that the positive electrode current collector 13A may be an electrical conductor having a surface covered with the first metal material. The electrical conductor is not limited to a particular material as long as the material is electrically conductive. In this case, the surface of the electrical conductor may be plated with the first metal material.

Here, the positive electrode active material layer 13B is provided on the entire positive electrode current collector 13A except for the coupling terminal part 13AT. However, the positive electrode active material layer 13B may be provided only on a part of the positive electrode current collector 13A except for the coupling terminal part 13AT.

The positive electrode active material layer 13B includes any one or more of positive electrode active materials which the alkali metal ion is to be inserted into and extracted from. Note that the positive electrode active material layer 13B may further include other materials including, without limitation, a positive electrode binder and a positive electrode conductor.

The positive electrode active material which a lithium ion is to be inserted into and extracted from as the alkali metal ion includes, for example, a lithium-containing compound. The lithium-containing compound is not particularly limited in kind, and specific examples thereof include a lithium composite oxide and a lithium phosphoric acid compound. The lithium composite oxide is an oxide including lithium and one or more of transition metal elements as constituent elements. The lithium phosphoric acid compound is a phosphoric acid compound including lithium and one or more of transition metal elements as constituent elements. The transition metal elements are not limited to particular kinds, and specific examples thereof include nickel, cobalt, manganese, and iron.

Specific examples of the lithium composite oxide having a layered rock-salt structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂. Specific examples of the lithium composite oxide having a spinel structure include LiMn₂O₄. Specific examples of the lithium phosphoric acid compound having an olivine crystal structure include LiFePO₄, LiMnPO₄, LiMn_{0.5}Fe_{0.5}PO₄, LiMn_{0.7}Fe_{0.3}PO₄, and LiMn_{0.75}Fe_{0.25}PO₄.

The positive electrode active material which a sodium ion is to be inserted into and extracted from as the alkali metal ion includes, for example, a sodium-containing compound. The sodium-containing compound is not particularly limited in kind, and specific examples thereof include a Prussian blue analog represented by Formula (1).

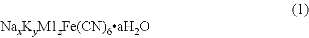

where: M1 is Mn, Zn, or both; x, y, and z satisfy 0.5<x≤2, 0≤y≤0.5, and 0≤z≤2; a is any value; and y may satisfy 0.05≤y≤0.2.

Specific examples of the Prussian blue analog represented by Formula (1) include Na₂MnFe(CN₆), Na_{1.42}K_{0.09}Mn_{1.13}Fe(CN)₆·3H₂O, and Na_{0.83}K_{0.12}Zn_{1.49}Fe(CN)₆·3.2H₂O.

The positive electrode active material which a potassium ion is to be inserted into and extracted from as the alkali metal ion includes, for example, a potassium-containing compound. Specific examples of the potassium-containing compound include K_{0.7}Fe_{0.6}Mn_{0.6}O₂, K_{0.6}MnO₂, K_{0.3}MnO₂, K_{0.31}CoO₂, KCrO₂, K_{0.6}CoO₂, K_{2/3}Mn_{2/3}Co_{1/3}Ni_{1/3}O₂, K_{2/3}Ni_{2/3}Te_{1/3}O₂, K_{2/3}Ni_{1/6}Co_{1/2}Te_{1/3}O₂, K_{2/3}Ni_{1/2}Mn_{1/6}Te_{1/3}O₂, K_{2/3}Ni_{1/2}Cu_{1/6}Te_{1/3}O₂, K_{2/3}Ni_{1/3}Zn_{1/3}Te_{1/3}O₂, K_{2/3}Ni_{1/6}Mg_{1/2}Te_{1/3}O₂, K_{2/3}Ni_{1/2}Co_{1/6}Te_{1/3}O₂, K_{2/3}Ni_{1/3}Mg_{1/3}Te_{1/3}O₂, and K_{2/3}Ni_{1/3}Co_{1/3}Te_{1/3}O₂.

The positive electrode binder includes any one or more of materials including, without limitation, a synthetic rubber and a polymer compound. Specific examples of the synthetic rubber include a styrene-butadiene-based rubber and a nitrile rubber. Specific examples of the polymer compound include an acrylic-based resin, polyvinylidene difluoride, polytetrafluoroethylene, and polyimide. The acrylic-based resin is a polymer of, for example, an acrylic acid ester and a methacrylic acid ester.

The positive electrode conductor includes any one or more of electrically conductive materials including, without limitation, a carbon material, a metal material, an electrically conductive ceramic material, and an electrically conductive polymer. Specific examples of the carbon material include graphite, carbon black, acetylene black, and Ketjen black.

The negative electrode 14 allows the alkali metal ion, which passes through the partition 12, to be inserted thereinto and extracted therefrom. The negative electrode 14 is contained in the negative electrode space S2, and more specifically, is immersed in the negative electrode aqueous electrolytic solution 16 contained in the negative electrode space S2.

Specifically, the negative electrode 14 includes the negative electrode current collector 14A and a negative electrode active material layer 14B.

The negative electrode current collector 14A is an electrically conductive member that supports the negative electrode active material layer 14B. The negative electrode current collector 14A includes any one or more of second metal materials. Specific examples of the second metal material include stainless steel (SUS), titanium, zinc, tin, lead, and alloys of two or more of these metals.

The stainless steel may be highly corrosion-resistant stainless steel that includes any one or more of additive elements including, without limitation, niobium and molybdenum added thereto. Specifically, the stainless steel may be SUS444 to which molybdenum is added. Specific examples of the electrically conductive ceramic material include indium tin oxide (ITO).

Note that the negative electrode current collector 14A is preferably insoluble or sparingly soluble in and resistant to corrosion by the negative electrode aqueous electrolytic solution 16, and has low reactivity to a negative electrode active material to be described later. One reason for this is that this suppresses degradation of the negative electrode current collector 14A upon operation of the secondary battery.

Here, the negative electrode current collector 14A includes the coupling terminal part 14AT. The coupling terminal part 14AT is an end part, of the negative electrode current collector 14A, on which no negative electrode active material layer 14B is provided. The coupling terminal part 14AT is led to the outside of the outer package member 11 through the negative electrode outlet 11PY. As described above, one reason for this is that this makes it possible for the secondary battery to be coupled to external equipment via the coupling terminal part 14AT.

A direction in which the coupling terminal part 14AT is led out is not particularly limited, and is specifically similar to a direction in which the coupling terminal part 13AT is led out.

However, the direction in which the coupling terminal part 14AT is led out and the direction in which the coupling terminal part 13AT is led out may be different from each other.

For example, an angle between the direction in which the coupling terminal part 14AT is led out and the direction in which the coupling terminal part 13AT is led out may be 180°, 90°, or any other angle. One reason for this is that the positive electrode 13 and the negative electrode 14 are disposed away from each other, which improves a handling property of the secondary battery, and also reduces a possibility that a short circuit will occur.

Note that the negative electrode current collector 14A may be an electrical conductor having a surface covered with the second metal material. The electrical conductor is not limited to a particular material as long as the material is electrically conductive. In this case, the surface of the electrical conductor may be plated with the second metal material.

Here, the negative electrode active material layer 14B is provided on the entire negative electrode current collector 14A except for the coupling terminal part 14AT. However, the negative electrode active material layer 14B may be provided only on a part of the negative electrode current collector 14A except for the coupling terminal part 14AT.

The negative electrode active material layer 14B includes any one or more of negative electrode active materials which the alkali metal ion is to be inserted into and extracted from. Note that the negative electrode active material layer 14B may further include other materials including, without limitation, a negative electrode binder and a negative electrode conductor.

The negative electrode active material includes, for example, a titanium-containing compound, a niobium-containing compound, a vanadium-containing compound, an iron-containing compound, and a molybdenum-containing compound. One reason for this is that this makes it easier for the charging and discharging reactions to proceed smoothly and stably even when two kinds of aqueous electrolytic solutions, i.e., the positive electrode aqueous electrolytic solution 15 and the negative electrode aqueous electrolytic solution 16, are used.

Examples of the titanium-containing compound include a titanium oxide, an alkali-metal-titanium composite oxide, a titanium phosphoric acid compound, an alkali metal titanium phosphoric acid compound, and a hydrogen titanium compound.

The titanium oxide is a compound represented by Formula (2), i.e., titanium oxide of a bronze type, for example.

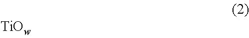

where w satisfies 1.85≤w≤2.15.

Specific examples of the titanium oxide include titanium dioxide (TiO₂) of an anatase type, a rutile type, or a brookite type. However, the titanium oxide may be a composite oxide including any one or more of elements including, without limitation, phosphorus, vanadium, tin, copper, nickel, iron, and cobalt as one or more constituent elements together with titanium. Specific examples of the composite oxide include TiO₂—P₂O₅, TiO₂—V₂O₅, TiO₂—P₂O₅—SnO₂, and TiO₂—P₂O₅-MeO, where Me is any one or more of elements including, without limitation, copper, nickel, iron, and cobalt.

One kind of the alkali-metal-titanium composite oxide is a lithium-titanium composite oxide, examples of which include respective compounds represented by Formulae (3) to (5), i.e., lithium titanate of a ramsdellite type. M3 in Formula (3) is a metal element that is to be a divalent ion. M4 in Formula (4) is a metal element that is to be a trivalent ion. M5 in Formula (5) is a metal element that is to be a tetravalent ion.

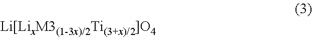

where: M3 is at least one of Mg, Ca, Cu, Zn, or Sr; and x satisfies 0≤x≤1/3.

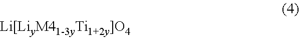

where: M4 is at least one of Al, Sc, Cr, Mn, Fe, Ge, or Y; and y satisfies 0≤y≤1/3.

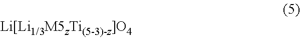

where: M5 is at least one of V, Zr, or Nb; and z satisfies 0≤z≤2/3.

Specific examples of the lithium-titanium composite oxide represented by Formula (3) include Li_{3.75}Ti_{4.875}Mg_{0.375}O₁₂. Specific examples of the lithium-titanium composite oxide represented by Formula (4) include LiCrTiO₄. Specific examples of the lithium-titanium composite oxide represented by Formula (5) include Li₄Ti₅O₁₂ and Li₄Ti_{4.95}Nb_{0.05}O₁₂.

Another kind of the alkali-metal-titanium composite oxide is a potassium-titanium composite oxide, specific examples of which include K₂Ti₃O₇ and K₄T₁₅O₁₂.

Specific examples of the titanium phosphoric acid compound include titanium phosphate (TiP₂O₇). One kind of the alkali metal titanium phosphoric acid compound is a lithium titanium phosphoric acid compound, specific examples of which include LiTi₂(PO₄)₃. Another kind of the alkali metal titanium phosphoric acid compound is a sodium titanium phosphoric acid compound, specific examples of which include NaTi₂(PO₄)₃. Specific examples of the hydrogen titanium compound include H₂Ti₃O₇(3TiO₂·1H₂O), H₆Ti₁₂O₂₇ (3TiO₂·0.75H₂O), H₂Ti₆O₁₃(3TiO₂·0.5H₂O), H₂Ti₇O₁₅(3TiO₂·0.43H₂O), and H₂Ti₁₂O₂₅(3TiO₂·0.25H₂O).

Examples of the niobium-containing compound include an alkali-metal-niobium composite oxide, a hydrogen niobium compound, and a titanium-niobium composite oxide. Note that a material belonging to the niobium-containing compound is excluded from the titanium-containing compound.

Specific examples of the alkali-metal-niobium composite oxide include LiNbO₂.

Specific examples of the hydrogen niobium compound include H₄Nb₆O₁₇. Specific examples of the titanium-niobium composite oxide include TiNb₂O₇ and Ti₂Nb₁₀O₂₉. The titanium-niobium composite oxide may be intercalated with the alkali metal.

Examples of the vanadium-containing compound include a vanadium oxide and an alkali-metal-vanadium composite oxide. Note that a material belonging to the vanadium-containing compound is excluded from each of the titanium-containing compound and the niobium-containing compound.

Specific examples of the vanadium oxide include vanadium dioxide (VO₂). Specific examples of the alkali-metal-vanadium composite oxide include LiV₂O₄ and LiV₃O₈.

Examples of the iron-containing compound include iron hydroxide. Note that a material belonging to the iron-containing compound is excluded from each of the titanium-containing compound, the niobium-containing compound, and the vanadium-containing compound.

Specific examples of the iron hydroxide include iron oxyhydroxide (FeOOH). The iron oxyhydroxide may be α-iron oxyhydroxide, β-iron oxyhydroxide, γ-iron oxyhydroxide, δ-iron oxyhydroxide, or any two or more thereof.

Examples of the molybdenum-containing compound include a molybdenum oxide and a cobalt-molybdenum composite oxide. Note that a material belonging to the molybdenum-containing compound is excluded from each of the titanium-containing compound, the niobium-containing compound, the vanadium-containing compound, and the iron-containing compound.

Specific examples of the molybdenum oxide include molybdenum dioxide (MoO₂). Specific examples of the cobalt-molybdenum composite oxide include CoMoO₄.

Details of the negative electrode binder are similar to those of the positive electrode binder. Details of the negative electrode conductor are similar to those of the positive electrode conductor.

The positive electrode aqueous electrolytic solution 15 is contained in the positive electrode space S1. Thus, the positive electrode aqueous electrolytic solution 15 is separated from the negative electrode aqueous electrolytic solution 16 contained in the negative electrode space S2 with the partition 12 interposed therebetween.

An amount of the positive electrode aqueous electrolytic solution 15 contained in the positive electrode space S1 is not particularly limited. Accordingly, the positive electrode aqueous electrolytic solution 15 may be contained in the entire positive electrode space S1, or may be contained only in a part of the positive electrode space S1. FIG. 1 illustrates a case where the positive electrode aqueous electrolytic solution 15 is so contained only in a part of the positive electrode space S1 that the entire positive electrode active material layer 13B is immersed in the positive electrode aqueous electrolytic solution 15.

Specifically, the positive electrode aqueous electrolytic solution 15 includes the aqueous solvent and the ionic material. The ionic material is a substance that is ionized in the aqueous solvent, and includes the alkali metal ion.

The aqueous solvent is not particularly limited in kind, and specifically includes any one or more of materials including, without limitation, pure water.

The ionic material is not particularly limited in kind, and specifically includes any one or more of electrolyte salts. Note that the ionic material may further include any one or more of other materials including, without limitation, an acid and a base. Specific examples of the acid include carbonic acid, oxalic acid, nitric acid, sulfuric acid, hydrochloric acid, acetic acid, and citric acid.

The electrolyte salt is a salt including a cation and an anion. More specifically, the electrolyte salt includes, as the cation, the alkali metal ion that is to be inserted into and extracted from each of the positive electrode 13 and the negative electrode 14, and thus includes any one or more of alkali metal salts each including such an alkali metal ion as the cation. One reason for this is that a high voltage is obtainable.

The alkali metal ion that is to be inserted into and extracted from each of the positive electrode 13 and the negative electrode 14 is hereinafter simply referred to as an “alkali metal ion”.

The alkali metal ion that is to be inserted into and extracted from each of the positive electrode 13 and the negative electrode 14 is not particularly limited in kind. Specific examples thereof include a lithium ion, a sodium ion, and a potassium ion.

Examples of the alkali metal salt that includes, as the cation, the alkali metal ion that is to be inserted into and extracted from each of the positive electrode 13 and the negative electrode 14 include a lithium salt, a sodium salt, and a potassium salt. Specific examples of the lithium salt include lithium carbonate, lithium oxalate, lithium nitrate, lithium sulfate, lithium chloride, lithium acetate, lithium citrate, lithium hydroxide, and an imide salt. Examples of the imide salt include lithium bis(fluorosulfonyl)imide and lithium bis(trifluoromethane sulfonyl)imide. Specific examples of the sodium salt include compounds that include the sodium ion in place of the lithium ion in the above-described specific examples of the lithium salt. Specific examples of the potassium salt include compounds that include the potassium ion in place of the lithium ion in the above-described specific examples of the lithium salt.

Note that the electrolyte salt may further include any one or more of alkali metal ions that are not to be inserted into and extracted from each of the positive electrode 13 and the negative electrode 14, and may thus include any one or more of alkali metal salts each including the one or more alkali metal ions as one or more cations.

Specific examples of the alkali metal ion that is not to be inserted into and extracted from each of the positive electrode 13 and the negative electrode 14 are similar to the specific examples of the alkali metal ion that is to be inserted into and extracted from each of the positive electrode 13 and the negative electrode 14. However, the alkali metal ion that is not to be inserted into and extracted from each of the positive electrode 13 and the negative electrode 14 and the alkali metal ion that is to be inserted into and extracted from each of the positive electrode 13 and the negative electrode 14 are different from each other in kind.

Specific examples of the alkali metal salt that includes, as the cation, the alkali metal ion that is not to be inserted into and extracted from each of the positive electrode 13 and the negative electrode 14 are similar to the above-described specific examples of the alkali metal salt that includes, as the cation, the alkali metal ion that is to be inserted into and extracted from each of the positive electrode 13 and the negative electrode 14. However, the alkali metal salt that includes, as the cation, the alkali metal ion that is not to be inserted into and extracted from each of the positive electrode 13 and the negative electrode 14 and the alkali metal salt that includes, as the cation, the alkali metal ion that is to be inserted into and extracted from each of the positive electrode 13 and the negative electrode 14 are different from each other in kind.

Further, the electrolyte salt may further include any one or more of other metal ions that are different from the alkali metal ion that is to be inserted into and extracted from each of the positive electrode 13 and the negative electrode 14 and the alkali metal ion that is not to be inserted into and extracted from each of the positive electrode 13 and the negative electrode 14, and may thus include any one or more of other metal salts each including the one or more other metal ions as one or more cations.

Example of the other metal ion include an alkaline earth metal ion, a transition metal ion, and any other metal ion. Specific examples of the alkaline earth metal ion include a magnesium ion and a calcium ion. Specific examples of the transition metal ion include a titanium ion, a vanadium ion, an iron ion, a manganese ion, a nickel ion, a cobalt ion, and a copper ion. Specific examples of the any other metal ion include an aluminum ion and a zinc ion.

Specific examples of the other metal salt that includes the other metal ion as the cation include respective compounds including the alkaline earth metal ion, the transition metal ion, and the any other metal ion, in place of the lithium ion in the above-described specific examples of the lithium salt.

In particular, the electrolyte salt preferably includes the alkali metal ion that is to be inserted into and extracted from each of the positive electrode 13 and the negative electrode 14 and the alkali metal ion that is not to be inserted into and extracted from each of the positive electrode 13 and the negative electrode 14. Thus, the electrolyte salt preferably includes any one or more of alkali metal salts each including, as the cation, the alkali metal ion that is to be inserted into and extracted from each of the positive electrode 13 and the negative electrode 14, and also includes any one or more of alkali metal salts each including, as the cation, the alkali metal ion that is not to be inserted into and extracted from each of the positive electrode 13 and the negative electrode 14. One reason for this is that this makes it easier to control a pH of the negative electrode aqueous electrolytic solution 16 to be sufficiently higher than a pH of the positive electrode aqueous electrolytic solution 15, as will be described later. This makes it easier to maintain a relationship between the pH of the positive electrode aqueous electrolytic solution 15 and the pH of the negative electrode aqueous electrolytic solution 16.

In this case, the alkali metal ion that is to be inserted into and extracted from each of the positive electrode 13 and the negative electrode 14 preferably includes the lithium ion. One reason for this is that a sufficiently high voltage is obtainable, and a high energy density is also obtainable.

Further, when the alkali metal ion that is to be inserted into and extracted from each of the positive electrode 13 and the negative electrode 14 includes the lithium ion, the alkali metal ion that is not to be inserted into and extracted from each of the positive electrode 13 and the negative electrode 14 preferably includes the potassium ion. That is, the electrolyte salt preferably includes the lithium ion and the potassium ion as the cations. This makes it sufficiently easier to maintain the above-described relationship between the pH of the positive electrode aqueous electrolytic solution 15 and the pH of the negative electrode aqueous electrolytic solution 16.

Note that the electrolyte salt may further include any one or more of non-electrolytes.

The anion is not particularly limited in kind. In particular, the anion preferably includes any one or more of ions including, without limitation, a nitric acid ion, a sulfuric acid ion, a hydrogen sulfuric acid ion, a carbonic acid ion, a hydrogen carbonic acid ion, a phosphoric acid ion, a monohydrogen phosphoric acid ion, a dihydrogen phosphoric acid ion, and a carboxylic acid ion. One reason for this is that this sufficiently suppresses variation in the pH of the positive electrode aqueous electrolytic solution 15, therefore making it sufficiently easier to maintain the relationship between the pH of the positive electrode aqueous electrolytic solution 15 and the pH of the negative electrode aqueous electrolytic solution 16. Specific examples of the carboxylic acid ion include a formic acid ion, an acetic acid ion, a propionic acid ion, a tartaric acid ion, and a citric acid ion.

In particular, the anion more preferably includes any one or more of ions including, without limitation, a nitric acid ion, a sulfuric acid ion, a hydrogen sulfuric acid ion, a carbonic acid ion, a hydrogen carbonic acid ion, a phosphoric acid ion, a monohydrogen phosphoric acid ion, and a dihydrogen phosphoric acid ion. One reason for this is that this further suppresses variation in the pH of the positive electrode aqueous electrolytic solution 15, therefore making it further easier to maintain the relationship between the pH of the positive electrode aqueous electrolytic solution 15 and the pH of the negative electrode aqueous electrolytic solution 16.

A composition (i.e., a kind of the aqueous solvent and a kind of the electrolyte salt) of the positive electrode aqueous electrolytic solution 15 and a composition (i.e., a kind of the aqueous solvent and a kind of the electrolyte salt) of the negative electrode aqueous electrolytic solution 16 may be the same as or different from each other.

A content of the ionic material in the positive electrode aqueous electrolytic solution 15, i.e., a concentration (mol/kg) of the positive electrode aqueous electrolytic solution 15, is not particularly limited, and may thus be set as desired.

<pH>

The pH of the positive electrode aqueous electrolytic solution 15 is lower than the pH of the negative electrode aqueous electrolytic solution 16. Accordingly, the pH of the negative electrode aqueous electrolytic solution 16 is higher than the pH of the positive electrode aqueous electrolytic solution 15.

One reason why the pH of the negative electrode aqueous electrolytic solution 16 is higher than the pH of the positive electrode aqueous electrolytic solution 15 is that a decomposition potential of the aqueous solvent shifts owing to the pH difference, as compared with a case where the pH of the negative electrode aqueous electrolytic solution 16 is the same as or lower than the pH of the positive electrode aqueous electrolytic solution 15. This thermodynamically suppresses a decomposition reaction of the aqueous solvent and also widens a potential window of the aqueous solvent upon charging and discharging. Accordingly, a high voltage is obtained, and the charging and discharging reactions utilizing insertion and extraction of the alkali metal ion also proceed sufficiently and stably.

In particular, it is preferable that the composition (i.e., the kind of the electrolyte salt) of the positive electrode aqueous electrolytic solution 15 and the composition (i.e., the kind of the electrolyte salt) of the negative electrode aqueous electrolytic solution 16 be different from each other. One reason for this is that this makes it easier to control the pH of the negative electrode aqueous electrolytic solution 16 to be higher than the pH of the positive electrode aqueous electrolytic solution 15.

The pH of the positive electrode aqueous electrolytic solution 15 is not particularly limited as long as the pH of the negative electrode aqueous electrolytic solution 16 is higher than the pH of the positive electrode aqueous electrolytic solution 15. In particular, the pH of the positive electrode aqueous electrolytic solution 15 is preferably within a range from 3 to 8 both inclusive, more preferably within a range from 4 to 8 both inclusive, and still more preferably within a range from 4 to 6 both inclusive. One reason for this is that this allows the positive electrode aqueous electrolytic solution 15 to have a sufficiently low pH, therefore making it easier for the pH of the positive electrode aqueous electrolytic solution 15 to be lower than the pH of the negative electrode aqueous electrolytic solution 16. Another reason for this is that this provides a sufficiently large difference between the pH of the positive electrode aqueous electrolytic solution 15 and the pH of the negative electrode aqueous electrolytic solution 16, therefore making it easier to maintain the relationship between the pH of the positive electrode aqueous electrolytic solution 15 and the pH of the negative electrode aqueous electrolytic solution 16. Still another reason for this is that this suppresses corrosion of, for example, the outer package member 11, the positive electrode current collector 13A, and the negative electrode current collector 14A.

Note that the pH of the positive electrode aqueous electrolytic solution 15 is preferably so set as to prevent each of the positive electrode current collector 13A and the positive electrode active material layer 13B from being corroded easily. One reason for this is that this makes it easier for the charging and discharging reactions using the positive electrode 13 to proceed stably and continuously.

Note that the positive electrode aqueous electrolytic solution 15 preferably includes a saturated solution of the electrolyte salt, that is, the positive electrode aqueous electrolytic solution 15 preferably includes a saturated solution of the alkali metal salt including, as the cation, the alkali metal ion that is to be inserted into and extracted from each of the positive electrode 13 and the negative electrode 14. One reason for this is that this makes it easier for insertion and extraction reactions of the alkali metal ion to proceed stably upon charging and discharging, and thus allows the charging and discharging reactions to proceed easily.

To check whether the positive electrode aqueous electrolytic solution 15 is the saturated solution of the electrolyte salt, the secondary battery is disassembled, following which whether the electrolyte salt is deposited in an inside of the positive electrode space S1 is visually checked. Specific examples of the inside of the positive electrode space S1 include a location in the positive electrode aqueous electrolytic solution 15, a location on a surface of the partition 12, a location on a surface of the positive electrode 13, and a location on the positive electrode inner wall surface 11WX of the outer package member 11. If the electrolyte salt is deposited and the positive electrode aqueous electrolytic solution 15, which is a liquid, and the deposited matter of the electrolyte salt, which is a solid, therefore coexist in the inside of the positive electrode space S1, it is assumable that the positive electrode aqueous electrolytic solution 15 is the saturated solution of the electrolyte salt. In order to examine a composition of the deposited matter, a surface analysis method such as X-ray photoelectron spectroscopy (XPS) may be used, or a composition analysis method such as inductively coupled plasma (ICP) optical emission spectroscopy may be used.

The positive electrode aqueous electrolytic solution 15 may be a pH buffer solution. The pH buffer solution may be an aqueous solution in which a weak acid and a conjugate base thereof are mixed together, an aqueous solution in which a weak base and a conjugate acid thereof are mixed together, or both. One reason for this is that this sufficiently suppresses variation in pH, therefore making it easier to maintain the pH of the positive electrode aqueous electrolytic solution 15.

The positive electrode aqueous electrolytic solution 15 may further include any one or more of buffers. Specific examples of the buffer include tris(hydroxymethyl)aminomethane and ethylenediaminetetraacetic acid.

The positive electrode aqueous electrolytic solution 15 may be an isotonic solution that is isotonic with the negative electrode aqueous electrolytic solution 16. One reason for this is that this makes osmotic pressure of the positive electrode aqueous electrolytic solution 15 appropriate, therefore making it easier to maintain the relationship between the pH of the positive electrode aqueous electrolytic solution 15 and the pH of the negative electrode aqueous electrolytic solution 16.

The negative electrode aqueous electrolytic solution 16 is contained in the negative electrode space S2. Thus, the negative electrode aqueous electrolytic solution 16 is separated from the positive electrode aqueous electrolytic solution 15 contained in the positive electrode space S1 with the partition 12 interposed therebetween.

An amount of the negative electrode aqueous electrolytic solution 16 contained in the negative electrode space S2 is not particularly limited. Accordingly, the negative electrode aqueous electrolytic solution 16 may be contained in the entire negative electrode space S2, or may be contained only in a part of the negative electrode space S2. FIG. 1 illustrates a case where the negative electrode aqueous electrolytic solution 16 is so contained only in a part of the negative electrode space S2 that the entire negative electrode active material layer 14B is immersed in the negative electrode aqueous electrolytic solution 16.

A configuration of the negative electrode aqueous electrolytic solution 16 is similar to that of the positive electrode aqueous electrolytic solution 15 described above except for those described below. That is, details of each of the aqueous solvent and the ionic material are as described above.

The anion is not particularly limited in kind. In particular, the anion preferably includes a hydroxide ion. One reason for this is that this sufficiently suppresses variation in the pH of the negative electrode aqueous electrolytic solution 16, therefore making it sufficiently easier to maintain the relationship between the pH of the positive electrode aqueous electrolytic solution 15 and the pH of the negative electrode aqueous electrolytic solution 16.

A content of the ionic material in the negative electrode aqueous electrolytic solution 16, i.e., a concentration (mol/kg) of the negative electrode aqueous electrolytic solution 16, is not particularly limited, and may thus be set as desired.

As described above, the pH of the negative electrode aqueous electrolytic solution 16 is higher than the pH of the positive electrode aqueous electrolytic solution 15.

It is preferable that the composition (i.e., the kind of the electrolyte salt) of the negative electrode aqueous electrolytic solution 16 and the composition (i.e., the kind of the electrolyte salt) of the positive electrode aqueous electrolytic solution 15 be different from each other. One reason for this is that this makes it easier to control the pH of the negative electrode aqueous electrolytic solution 16 to be higher than the pH of the positive electrode aqueous electrolytic solution 15.

The pH of the negative electrode aqueous electrolytic solution 16 is not particularly limited as long as the pH of the negative electrode aqueous electrolytic solution 16 is higher than the pH of the positive electrode aqueous electrolytic solution 15. In particular, the pH of the negative electrode aqueous electrolytic solution 16 is preferably higher than or equal to 11, more preferably higher than or equal to 12, and still more preferably higher than or equal to 13. One reason for this is that this allows the negative electrode aqueous electrolytic solution 16 to have a sufficiently high pH, therefore making it easier for the pH of the negative electrode aqueous electrolytic solution 16 to be higher than the pH of the positive electrode aqueous electrolytic solution 15. Another reason for this is that this provides a sufficiently large difference between the pH of the positive electrode aqueous electrolytic solution 15 and the pH of the negative electrode aqueous electrolytic solution 16, therefore making it easier to maintain the relationship between the pH of the positive electrode aqueous electrolytic solution 15 and the pH of the negative electrode aqueous electrolytic solution 16.

Note that the pH of the negative electrode aqueous electrolytic solution 16 is preferably so set as to prevent each of the negative electrode current collector 14A and the negative electrode active material layer 14B from being corroded easily. One reason for this is that this makes it easier for the charging and discharging reactions using the negative electrode 14 to proceed stably and continuously.

Note that the negative electrode aqueous electrolytic solution 16 is preferably a saturated solution of the electrolyte salt, that is, the negative electrode aqueous electrolytic solution 16 is preferably a saturated solution of the alkali metal salt including, as the cation, the alkali metal ion that is to be inserted into and extracted from each of the positive electrode 13 and the negative electrode 14. One reason for this is that this makes it easier for insertion and extraction reactions of the alkali metal ion to proceed stably upon charging and discharging, and thus allows the charging and discharging reactions to proceed easily.

A method of checking whether the negative electrode aqueous electrolytic solution 16 is the saturated solution of the electrolyte salt is similar to the above-described method of checking whether the positive electrode aqueous electrolytic solution 15 is the saturated solution of the electrolyte salt, except that the negative electrode space S2 is checked instead of the positive electrode space S1.

The negative electrode aqueous electrolytic solution 16 may be a pH buffer solution. One reason for this is that this sufficiently suppresses variation in pH, therefore making it easier to maintain the pH of the negative electrode aqueous electrolytic solution 16.

The negative electrode aqueous electrolytic solution 16 may further include any one or more of buffers. Details of the buffers are as described above.

The negative electrode aqueous electrolytic solution 16 may be an isotonic solution that is isotonic with the positive electrode aqueous electrolytic solution 15. One reason for this is that this makes osmotic pressure of the negative electrode aqueous electrolytic solution 16 appropriate, therefore making it easier to maintain the relationship between the pH of the positive electrode aqueous electrolytic solution 15 and the pH of the negative electrode aqueous electrolytic solution 16.

The positive electrode sealing member 17 is a member that is disposed inside the positive electrode outlet 11PX to thereby seal a gap between the outer package member 11 and the positive electrode current collector 13A (the coupling terminal part 13AT). Thus, the positive electrode sealing member 17 is disposed between the outer package member 11 and the coupling terminal part 13AT inside the positive electrode outlet 11PX, and is adjacent to each of the outer package member 11 and the coupling terminal part 13AT.

The positive electrode sealing member 17 includes, in order to close the gap between the outer package member 11 and the coupling terminal part 13AT inside the positive electrode outlet 11PX, any one or more of third polymer compounds that are bondable to each of the outer package member 11 and the coupling terminal part 13AT.

The third polymer compound is not particularly limited in kind as long as it is bondable to each of the outer package member 11 and the coupling terminal part 13AT. Specific examples of the third polymer compound include an acid-modified polyolefin. One reason for this is that this sufficiently improves a bonding strength of the positive electrode sealing member 17 to each of the outer package member 11 and the coupling terminal part 13AT, and thus allows the gap between the outer package member 11 and the coupling terminal part 13AT inside the positive electrode outlet 11PX to be sufficiently sealed.

Thus, a liquid sealing property and a gas sealing property in the inside (the positive electrode space S1) of the outer package member 11 provided with the positive electrode outlet 11PX are secured. This prevents easy leakage of the positive electrode aqueous electrolytic solution 15 from the outer package member 11, and also prevents easy entry and exit of each of the liquid and the gas through the positive electrode outlet 11PX.

A method of bonding the positive electrode sealing member 17 to each of the outer package member 11 and the coupling terminal part 13AT is not particularly limited. In particular, the positive electrode sealing member 17 is preferably thermal-fusion-bonded to each of the outer package member 11 and the coupling terminal part 13AT. One reason for this is that a chemical bonding strength of the positive electrode sealing member 17 to each of the outer package member 11 and the coupling terminal part 13AT sufficiently improves.

The negative electrode sealing member 18 is a member that is disposed inside the negative electrode outlet 11PY to thereby seal a gap between the outer package member 11 and the negative electrode current collector 14A (the coupling terminal part 14AT). Thus, the negative electrode sealing member 18 is disposed between the outer package member 11 and the coupling terminal part 14AT inside the negative electrode outlet 11PY, and is adjacent to each of the outer package member 11 and the coupling terminal part 14AT.

The negative electrode sealing member 18 includes, in order to close the gap between the outer package member 11 and the coupling terminal part 14AT inside the negative electrode outlet 11PY, any one or more of fourth polymer compounds that are bondable to each of the outer package member 11 and the coupling terminal part 14AT.

Details of the fourth polymer compound are similar to those of the third polymer compound described above. That is, specific examples of the fourth polymer compound include an acid-modified polyolefin.

In this case, a bonding strength of the negative electrode sealing member 18 to each of the outer package member 11 and the coupling terminal part 14AT sufficiently improves, which allows the gap between the outer package member 11 and the coupling terminal part 14AT inside the negative electrode outlet 11PY to be sufficiently sealed. Thus, a liquid sealing property and a gas sealing property in the inside (the negative electrode space S2) of the outer package member 11 provided with the negative electrode outlet 11PY are secured. This prevents easy leakage of the negative electrode aqueous electrolytic solution 16 from the outer package member 11, and also prevents easy entry and exit of each of the liquid and the gas through the negative electrode outlet 11PY.

A method of bonding the negative electrode sealing member 18 to each of the outer package member 11 and the coupling terminal part 14AT is not particularly limited. In particular, the negative electrode sealing member 18 is preferably thermal-fusion-bonded to each of the outer package member 11 and the coupling terminal part 14AT. One reason for this is that a chemical bonding strength of the negative electrode sealing member 18 to each of the outer package member 11 and the coupling terminal part 14AT sufficiently improves.

The secondary battery operates as described below upon charging and discharging.

Upon charging, the alkali metal ion is extracted from the positive electrode 13, and the extracted alkali metal ion moves through the positive electrode aqueous electrolytic solution 15, the partition 12, and the negative electrode aqueous electrolytic solution 16 in this order to the negative electrode 14. Thus, the alkali metal ion is inserted into the negative electrode 14.

Upon discharging, the alkali metal ion is extracted from the negative electrode 14, and the extracted alkali metal ion moves through the negative electrode aqueous electrolytic solution 16, the partition 12, and the positive electrode aqueous electrolytic solution 15 in this order to the positive electrode 13. Thus, the alkali metal ion is inserted into the positive electrode 13. The secondary battery is manufactured in accordance with a procedure described below.

First, the positive electrode active material, the positive electrode binder, and the positive electrode conductor are mixed with each other to thereby obtain a positive electrode mixture. Thereafter, the positive electrode mixture is put into a solvent to thereby prepare a positive electrode mixture slurry in paste form. The solvent may be an aqueous solvent, or may be an organic solvent. Lastly, the positive electrode mixture slurry is applied on a surface of the positive electrode current collector 13A excluding the coupling terminal part 13AT to thereby form the positive electrode active material layer 13B. Thereafter, the positive electrode active material layer 13B may be compression-molded using a compression device such as a roll pressing machine. In this case, the positive electrode active material layer 13B may be heated. The positive electrode active material layers 13B may be compression-molded multiple times. The positive electrode active material layer 13B is thus formed on each of two opposed surfaces of the positive electrode current collector 13A. As a result, the positive electrode 13 is fabricated.

The negative electrode active material layer 14B is formed on each of two opposed surfaces of the negative electrode current collector 14A by a procedure similar to the procedure for fabricating the positive electrode 13 described above. Specifically, the negative electrode active material, the negative electrode binder, and the negative electrode conductor are mixed with each other to thereby obtain a negative electrode mixture, following which the negative electrode mixture is put into the solvent to thereby prepare a negative electrode mixture slurry in paste form. Thereafter, the negative electrode mixture slurry is applied on a surface of the negative electrode current collector 14A excluding the coupling terminal part 14AT to thereby form the negative electrode active material layer 14B. Thereafter, the negative electrode active material layer 14B may be compression-molded. The negative electrode active material layer 14B is thus formed on each of the two opposed surfaces of the negative electrode current collector 14A. As a result, the negative electrode 14 is fabricated.

The ionic material is put into the aqueous solvent. The ionic material is thereby dispersed or dissolved in the aqueous solvent. As a result, the positive electrode aqueous electrolytic solution 15 is prepared.

The negative electrode aqueous electrolytic solution 16 is so prepared as to have the pH higher than the pH of the positive electrode aqueous electrolytic solution 15, by a procedure similar to the procedure for preparing the positive electrode aqueous electrolytic solution 15 described above.

First, the outer edge part 12A and the body part 12B are brought into contact with each other, following which the outer edge part 12A and the body part 12B are heated. As a result, the outer edge part 12A and the body part 12B are thermal-fusion-bonded to each other, and are thus rigidly joined to each other. The partition 12 including the outer edge part 12A and the body part 12B is thus obtained.

A heating temperature upon the thermal fusion bonding is not particularly limited, and may be set as desired. Specifically, the heating temperature is preferably higher than or equal to 100° C., and more preferably higher than or equal to 200° C. One reason for this is that the outer edge part 12A and the body part 12B are sufficiently thermal-fusion-bonded to each other. Thereafter, the partition 12 is provided inside the outer package member 11.

In this case, the outer package member 11 and the outer edge part 12A are brought into contact with each other, following which the outer package member 11 and the outer edge part 12A are heated. As a result, the outer package member 11 and the outer edge part 12A are thermal-fusion-bonded to each other. The outer package member 11 and the outer edge part 12A are thus rigidly joined to each other.

Details of a heating temperature when the outer package member 11 and the outer edge part 12A are thermal-fusion-bonded to each other are similar to the details of the heating temperature when the outer edge part 12A and the body part 12B are thermal-fusion-bonded to each other.

The partition 12 is thus provided inside the outer package member 11. As a result, the positive electrode space S1 and the negative electrode space S2 that are separated from each other with the partition 12 interposed therebetween are formed.

Thereafter, each of the positive electrode 13 and the negative electrode 14 is disposed inside the outer package member 11.

In this case, the positive electrode 13 is placed into the positive electrode space S1 from the positive electrode outlet 11PX. The positive electrode 13 is thereby so contained in the positive electrode space S1 that the coupling terminal part 13AT is led to the outside of the outer package member 11 through the positive electrode outlet 11PX.

The negative electrode 14 is placed into the negative electrode space S2 from the negative electrode outlet 11PY. The negative electrode 14 is thereby so contained in the negative electrode space S2 that the coupling terminal part 14AT is led to the outside of the outer package member 11 through the negative electrode outlet 11PY.

Thereafter, the positive electrode aqueous electrolytic solution 15 is supplied to the positive electrode space S1 from the gap between the outer package member 11 and the coupling terminal part 13AT provided inside the positive electrode outlet 11PX. Thus, the positive electrode aqueous electrolytic solution 15 is placed in the positive electrode space S1, and the positive electrode 13 is immersed in the positive electrode aqueous electrolytic solution 15.

The negative electrode aqueous electrolytic solution 16 is supplied to the negative electrode space S2 from the gap between the outer package member 11 and the coupling terminal part 14AT provided inside the negative electrode outlet 11PY. Thus, the negative electrode aqueous electrolytic solution 16 is placed in the negative electrode space S2, and the negative electrode 14 is immersed in the negative electrode aqueous electrolytic solution 16.

Lastly, the positive electrode outlet 11PX is sealed using the positive electrode sealing member 17, and the negative electrode outlet 11PY is sealed using the negative electrode sealing member 18.

In this case, the positive electrode sealing member 17 is disposed between the outer package member 11 and the coupling terminal part 13AT inside the positive electrode outlet 11PX, following which the positive electrode sealing member 17 is heated. Thus, the positive electrode sealing member 17 is thermal-fusion-bonded to each of the outer package member 11 and the coupling terminal part 13AT. As a result, the positive electrode outlet 11PX is hermetically closed with use of the positive electrode sealing member 17.

The negative electrode sealing member 18 is disposed between the outer package member 11 and the coupling terminal part 14AT inside the negative electrode outlet 11PY, following which the negative electrode sealing member 18 is heated. Thus, the negative electrode sealing member 18 is thermal-fusion-bonded to each of the outer package member 11 and the coupling terminal part 14AT. As a result, the negative electrode outlet 11PY is hermetically closed with use of the negative electrode sealing member 18.

Thus, the partition 12, the positive electrode 13, the negative electrode 14, the positive electrode aqueous electrolytic solution 15, and the negative electrode aqueous electrolytic solution 16 are contained in the outer package member 11. As a result, the secondary battery is completed.

According to the secondary battery, the positive electrode space S1 and the negative electrode space S2 are separated from each other with the partition 12 interposed therebetween, and the partition 12 includes the outer edge part 12A and the body part 12B. The body part includes the cation exchange membrane. The outer edge part 12A includes the first polymer compound. The first polymer compound may include any one or more of the hydroxyl group, the primary amino group, the secondary amino group, the primary amide group, the secondary amide group, or the carboxyl group.

In this case, a series of kinds of action described below is achieved, as described above.

First, the body part 12B includes the cation exchange membrane, and this makes it easier for an appropriate amount of aqueous solvent within the aqueous solvent included in the positive electrode aqueous electrolytic solution 15 to permeate into the body part 12B, and also makes it easier for an appropriate amount of aqueous solvent within the aqueous solvent included in the negative electrode aqueous electrolytic solution 16 to permeate into the body part 12B. This allows for an improvement in ion conductivity inside the body part 12B.

Second, the outer edge part 12A including the first polymer compound includes the one or more appropriate functional groups described above, and this secures the chemical bonding strength between the outer edge part 12A and the body part 12B. As a result, the outer edge part 12A and the body part 12B are rigidly joined to each other, and are thus rigidly fixed to each other. In this case, in particular, the outer edge part 12A and the body part 12B are thermal-fusion-bonded to each other, and are thus sufficiently rigidly fixed to each other. This secures the liquid sealing property inside the outer package member 11, which suppresses the leakage of each of the positive electrode aqueous electrolytic solution 15 and the negative electrode aqueous electrolytic solution 16, and also suppresses the mixing of the positive electrode aqueous electrolytic solution 15 and the negative electrode aqueous electrolytic solution 16.

Based upon the foregoing, in the secondary battery including two kinds of aqueous electrolytic solutions, i.e., the positive electrode aqueous electrolytic solution 15 and the negative electrode aqueous electrolytic solution 16, a sealed state of the positive electrode aqueous electrolytic solution 15 and the negative electrode aqueous electrolytic solution 16 inside the outer package member 11 is secured and a separated state of the positive electrode aqueous electrolytic solution 15 and the negative electrode aqueous electrolytic solution 16 with the partition 12 interposed therebetween is also secured, while the ion conductivity of the alkali metal ion in the partition 12 is secured.

Accordingly, the charging and discharging reactions proceed stably even if the two kinds of aqueous electrolytic solutions are used. It is therefore possible to achieve a superior operation characteristic.

In particular, all of the outer edge part 12A may include the first polymer compound. This allows all of the outer edge part 12A and the body part 12B to be rigidly fixed to each other. Accordingly, the liquid sealing property inside the outer package member 11 further improves. It is therefore possible to achieve higher effects.

Further, the outer edge part 12A and the body part 12B may be integrated with each other. This allows for a sufficient improvement in the liquid sealing property owing to the partition 12 inside the outer package member 11. It is therefore possible to achieve higher effects.

The body part 12B may be positioned on the inner side relative to the outer edge part 12A inside the outer package member 11, and the body part 12B may thus be unexposed to the outside of the outer package member 11. This prevents easy leakage of each of the positive electrode aqueous electrolytic solution 15 and the negative electrode aqueous electrolytic solution 16 from the body part 12B to the outside of the outer package member 11. It is therefore possible to achieve higher effects.

Further, the cation exchange membrane may include the sulfonic acid ion group, the carboxylic acid ion group, or both as the one or more anionic groups. This allows the outer edge part 12A to have a high affinity with the anionic groups. Accordingly, the outer edge part 12A and the body part 12B are more rigidly fixed to each other. It is therefore possible to achieve higher effects.

Further, the first polymer compound may include one or more of nylon, polyvinyl alcohol, or an ethylene-vinyl alcohol copolymer. This sufficiently improves the bonding strength between the outer edge part 12A and the body part 12B. It is therefore possible to achieve higher effects.

Further, the outer package member 11 may include the second polymer compound, and the second polymer compound may include any one or more of polyethylene, polypropylene, polyethylene terephthalate, polytetrafluoroethylene, or polyvinyl chloride. This makes it possible for the outer package member 11 to achieve a high hermetically closed property. It is therefore possible to achieve higher effects.

In this case, the material (the first polymer compound) included in the outer edge part 12A is compatible with the outer package member 11 (the second polymer compound). The outer package member 11 and the outer edge part 12A are thus rigidly joined to each other. Accordingly, the liquid sealing property inside the outer package member 11 further improves. It is therefore possible to achieve even higher effects.

Further, the positive electrode current collector 13A (the coupling terminal part 13AT) is led to the outside of the outer package member 11 through the positive electrode outlet 11PX, the positive electrode sealing member 17 is adjacent to each of the outer package member 11 and the coupling terminal part 13AT inside the positive electrode outlet 11PX, the coupling terminal part 13AT includes the first metal material, the positive electrode sealing member 17 includes the third polymer compound, and the details of each of the first metal material and the third polymer compound are as described above. In this case, the bonding strength of the positive electrode sealing member 17 to each of the outer package member 11 and the coupling terminal part 13AT sufficiently improves, which allows the gap between the outer package member 11 and the coupling terminal part 13AT inside the positive electrode outlet 11PX to be sufficiently sealed. Thus, the liquid sealing property and the gas sealing property in the inside (the positive electrode space S1) of the outer package member 11 provided with the positive electrode outlet 11PX are secured. It is therefore possible to achieve higher effects.

Further, the negative electrode current collector 14A (the coupling terminal part 14AT) is led to the outside of the outer package member 11 through the negative electrode outlet 11PY, the negative electrode sealing member 18 is adjacent to each of the outer package member 11 and the coupling terminal part 14AT inside the negative electrode outlet 11PY, the coupling terminal part 14AT includes the second metal material, the negative electrode sealing member 18 includes the fourth polymer compound, and the details of each of the second metal material and the fourth polymer compound are as described above. In this case, the bonding strength of the negative electrode sealing member 18 to each of the outer package member 11 and the coupling terminal part 14AT sufficiently improves, which allows the gap between the outer package member 11 and the coupling terminal part 14AT inside the negative electrode outlet 11PY to be sufficiently sealed. Thus, the liquid sealing property and the gas sealing property in the inside (the negative electrode space S2) of the outer package member 11 provided with the negative electrode outlet 11PY are secured. It is therefore possible to achieve higher effects.

Further, the contact angle of the positive electrode aqueous electrolytic solution 15 with respect to the positive electrode inner wall surface 11WX of the outer package member 11 may be less than or equal to 150°. This secures the wettability of the positive electrode inner wall surface 11WX with respect to the positive electrode aqueous electrolytic solution 15. Accordingly, this makes it easier for the charging and discharging reactions to proceed sufficiently upon charging and discharging. It is therefore possible to achieve higher effects.

Further, the contact angle of the negative electrode aqueous electrolytic solution 16 with respect to the negative electrode inner wall surface 11WY of the outer package member 11 may be less than or equal to 150°. This secures the wettability of the negative electrode inner wall surface 11WY with respect to the negative electrode aqueous electrolytic solution 16. Accordingly, this makes it easier for the charging and discharging reactions to proceed sufficiently upon charging and discharging. It is therefore possible to achieve higher effects.

Further, the pH of the negative electrode aqueous electrolytic solution 16 may be higher than the pH of the positive electrode aqueous electrolytic solution 15. This causes the decomposition potential of the aqueous solvent to shift, which thermodynamically suppresses the decomposition reaction of the aqueous solvent and also widens the potential window of the aqueous solvent upon charging and discharging. Accordingly, a high voltage is obtained, and the charging and discharging reactions utilizing insertion and extraction of the alkali metal ion also proceed sufficiently and stably. It is therefore possible to achieve higher effects.

In this case, the pH of the negative electrode aqueous electrolytic solution 16 may be higher than or equal to 11 and the pH of the positive electrode aqueous electrolytic solution 15 may be within the range from 3 to 8 both inclusive. This makes it easier to maintain the relationship between the pH of the positive electrode aqueous electrolytic solution 15 and the pH of the negative electrode aqueous electrolytic solution 16. It is therefore possible to achieve even higher effects.

In addition, in the process of manufacturing the secondary battery described above, the outer edge part 12A and the body part 12B are thermal-fusion-bonded to each other, and the partition 12 is thereby formed. Thus, the outer edge part 12A and the body part 12B are rigidly fixed to each other, as described above. Accordingly, for the reasons described above, the charging and discharging reactions proceed stably even if the two kinds of aqueous electrolytic solutions, i.e., the positive electrode aqueous electrolytic solution 15 and the negative electrode aqueous electrolytic solution 16, are used. It is therefore possible to achieve a secondary battery having a superior operation characteristic.

Next, a description is given of modification examples of the secondary battery.

The configuration of the secondary battery described above is appropriately modifiable, as described below. Note that any two or more of the following series of modification examples may be combined with each other.

In FIGS. 1 and 2, all of the outer edge part 12A includes the first polymer compound. However, although not specifically illustrated here, only a part of the outer edge part 12A may include the first polymer compound.

A part, of the outer edge part 12A, that includes the first polymer compound may be provided at only one location, or at each of two or more locations that are separated from each other. Note that a part, of the outer edge part 12A, that does not include the first polymer compound includes the cation exchange membrane, as with the body part 12B.

In this case also, the liquid sealing property inside the outer package member 11 improves as compared with a case where all of the outer edge part 12A does not include the first polymer compound, and similar effects are therefore achievable.

In FIG. 1, the secondary battery includes both the positive electrode sealing member 17 and the negative electrode sealing member 18. However, the secondary battery may include either the positive electrode sealing member 17 or the negative electrode sealing member 18, or may include neither the positive electrode sealing member 17 nor the negative electrode sealing member 18.

Specifically, the secondary battery may include no negative electrode sealing member 18, and may include only the positive electrode sealing member 17. In this case, the positive electrode outlet 11PX is hermetically closed with use of the positive electrode sealing member 17, whereas a method of hermetically closing the negative electrode outlet 11PY is not particularly limited. Specifically, the negative electrode outlet 11PY may be hermetically closed with use of an insulating polymer compound such as an epoxy resin, a silicone resin, a phenol resin, or a polyimide resin.

In this case also, the liquid sealing property and the gas sealing property in the positive electrode space S1 improves as compared with the case where the secondary battery includes neither the positive electrode sealing member 17 nor the negative electrode sealing member 18, and similar effects are therefore achievable.

Alternatively, the secondary battery may include no positive electrode sealing member 17, and may include only the negative electrode sealing member 18. In this case, the negative electrode outlet 11PY is hermetically closed with use of the negative electrode sealing member 18, whereas a method of hermetically closing the positive electrode outlet 11PX is not particularly limited. Specifically, the positive electrode outlet 11PX may be hermetically closed with use of an insulating polymer compound such as an epoxy resin, a silicone resin, a phenol resin, or a polyimide resin.

In this case also, the liquid sealing property and the gas sealing property in the negative electrode space S2 improves as compared with the case where the secondary battery includes neither the positive electrode sealing member 17 nor the negative electrode sealing member 18, and similar effects are therefore achievable.

In FIG. 1, the outer edge part 12A is disposed inside the outer package member 11. The outer edge part 12A is thus unexposed to the outside of the outer package member 11.

However, as illustrated in FIG. 3 corresponding to FIG. 1, the outer edge part 12A may be exposed from the outer package member 11. In this case, the outer package member 11 is divided into two parts, i.e., outer package containers 11X and 11Y, and the outer package containers 11X and 11Y are joined to each other with the outer edge part 12A interposed therebetween.

In this case also, the outer edge part 12A and the body part 12B are rigidly joined to each other, and similar effects are therefore achievable.

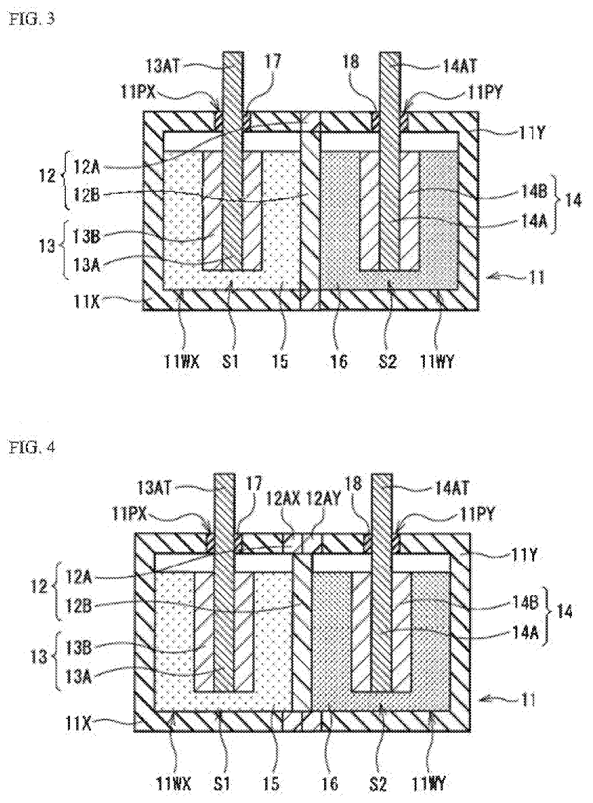

In FIG. 1, the outer edge part 12A has an integrated structure. However, as illustrated in FIG. 4 corresponding to FIG. 1, the outer edge part 12A may include end parts 12AX and 12AY, and the end parts 12AX and 12AY may have a structure of being joined to each other.

A configuration of a secondary battery illustrated in FIG. 4 is similar to the configuration of the secondary battery illustrated in FIG. 1 except for those described below.

The outer package member 11 includes the pair of outer package containers 11X and 11Y separated from each other at a placement location of the partition 12.

The end parts 12AX and 12AY are chemically bonded to each other to thereby form the outer edge part 12A. The outer edge part 12A is chemically bonded to the body part 12B, and is also chemically bonded to the outer package member 11.

A method of manufacturing the secondary battery illustrated in FIG. 4 is similar to the method of manufacturing the secondary battery illustrated in FIG. 1 except for those described below.

To assemble the secondary battery, first, the outer package containers 11X and 11Y that are separated from each other are prepared.

The outer package container 11X has a shape of a container with an opening, and includes the positive electrode outlet 11PX. The outer package container 11Y has a shape of a container with an opening, and includes the negative electrode outlet 11PY.

Here, the end part 12AX is thermal-fusion-bonded to the outer package container 11X in advance, and the end part 12AY is thermal-fusion-bonded to the outer package container 11Y in advance. Note, however, that the end parts 12AX and 12AY are so disposed at respective positions that are to be opposed to each other as to be thermal-fusion-bondable to each other in a process of forming the outer package member 11 to be described later.

Thereafter, the outer package containers 11X and 11Y are so disposed that the respective openings are opposed to each other and the end parts 12AX and 12AY are opposed to each other, following which the outer package containers 11X and 11Y are brought close to each other until the end parts 12AX and 12AY come into contact with each other. In this case, the body part 12B is disposed between the outer package containers 11X and 11Y to thereby contain the body part 12B inside the outer package containers 11X and 11Y.

Lastly, the end parts 12AX and 12AY are heated to thereby cause the end parts 12AX and 12AY to be thermal-fusion-bonded to each other, and also cause the end parts 12AX and 12AY to be thermal-fusion-bonded to the body part 12B.

As a result, the outer package containers 11X and 11Y are joined to each other with the outer edge part 12A, i.e., the end parts 12AX and 12AY, interposed therebetween. The outer package member 11 is thus formed. Further, the outer edge part 12A is, or the end parts 12AX and 12AY are, rigidly joined to the body part 12B. The secondary battery is thus completed.

In this case also, the outer edge part 12A and the body part 12B are rigidly joined to each other, and similar effects are therefore achievable.

In this case, in particular, the end parts 12AX and 12AY are easily thermal-fusion-bonded to the body part 12B even if the outer edge part 12A and the body part 12B are separated from each other at first, therefore making it easier for the outer edge part 12A to be rigidly fixed to the body part 12B. Accordingly, it is possible to further improve operational stability, and also to easily manufacture the secondary battery.

The end parts 12AX and 12AY included in the outer edge part 12A are used in Modification example 4; however, respective configurations of the end parts 12AX and 12AY may be changed.

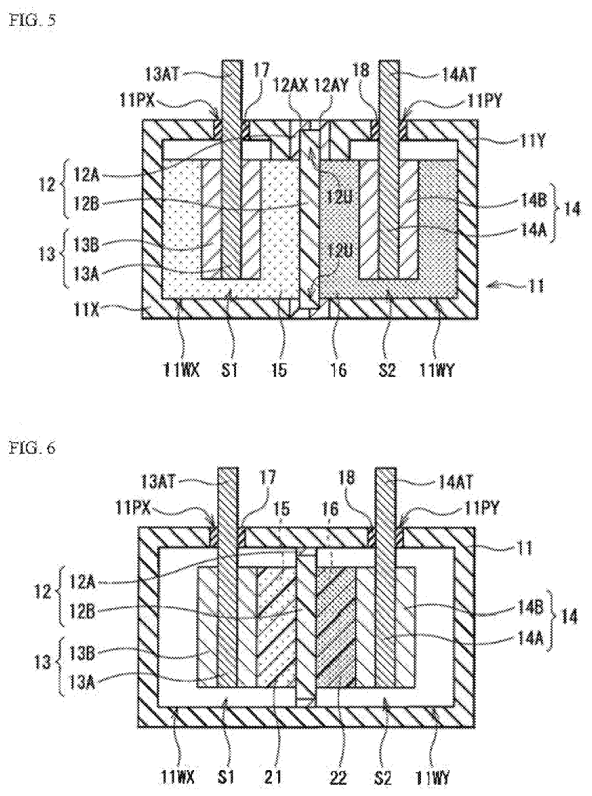

Specifically, as illustrated in FIG. 5 corresponding to FIG. 4, the end parts 12AX and 12AY may each be so partially recessed that a recessed part 12U is formed in a state where the end parts 12AX and 12AY are joined to each other. The body part 12B is disposed in the recessed part 12U, and is thus held by the end parts 12AX and 12AY in the state of being disposed in the recessed part 12U.

In this case, an end part, of the outer package container 11X, to which the end part 12AX is to be thermal-fusion-bonded in advance may extend along the body part 12B, and an end part, of the outer package container 11Y, to which the end part 12AY is to be thermal-fusion-bonded in advance may extend along the body part 12B. As a result, the end part of the outer package container 11X may bend toward an inside of the outer package container 11X, and the end part of the outer package container 11Y may bend toward an inside of the outer package container 11Y.

The secondary battery is assembled with use of the outer package container 11X to which the end part 12AX is thermal-fusion-bonded in advance and the outer package container 11Y to which the end part 12AY is thermal-fusion-bonded in advance. A method of manufacturing the secondary battery of Modification example 5 is similar to the method of manufacturing the secondary battery of Modification example 4, except that the respective configurations of the end parts 12AX and 12AY are different.

In this case also, the outer edge part 12A and the body part 12B are rigidly joined to each other, and similar effects are therefore achievable.

In this case, in particular, the body part 12B is disposed in the recessed part 12U, as described above. As a result, the body part 12B is stably held with use of the end parts 12AX and 12AY, which makes it possible to suppress displacement of the partition 12. Further, a contact area between the outer edge part 12A and the body part 12B is increased, which makes it possible to more stably thermal-fusion-bond the outer edge part 12A to the body part 12B.

Exemplified as the negative electrode active material are the titanium-containing compound, the niobium-containing compound, the vanadium-containing compound, the iron-containing compound, and the molybdenum-containing compound. However, as long as it is easy for the charging and discharging reactions to proceed smoothly and stably even if two kinds of aqueous electrolytic solutions, i.e., the positive electrode aqueous electrolytic solution 15 and the negative electrode aqueous electrolytic solution 16, are used, the negative electrode active material may include any other compound. In this case also, similar effects are achievable.

In FIG. 1, the electrolytic solutions, i.e., the positive electrode aqueous electrolytic solution 15 and the negative electrode aqueous electrolytic solution 16, that are liquid electrolytes are used. However, as illustrated in FIG. 6 corresponding to FIG. 1, electrolyte layers 21 and 22 may be used instead of the positive electrode aqueous electrolytic solution 15 and the negative electrode aqueous electrolytic solution 16. The electrolyte layers 21 and 22 are gel electrolytes.

When the electrolyte layers 21 and 22 are used, as illustrated in FIG. 6, the electrolyte layer 21 is interposed between the partition 12 and the positive electrode 13, and the electrolyte layer 22 is interposed between the partition 12 and the negative electrode 14. Thus, the electrolyte layer 21 is adjacent to each of the partition 12 and the positive electrode 13, and the electrolyte layer 22 is adjacent to each of the partition 12 and the negative electrode 14.

Specifically, the electrolyte layer 21 includes the positive electrode aqueous electrolytic solution 15 and a polymer compound, and the positive electrode aqueous electrolytic solution 15 is held by the polymer compound. One reason for this is that leakage of the positive electrode aqueous electrolytic solution 15 is prevented. In FIG. 6, the electrolyte layer 21 including the positive electrode aqueous electrolytic solution 15 is lightly shaded.

The electrolyte layer 22 includes the negative electrode aqueous electrolytic solution 16 and a polymer compound, and the negative electrode aqueous electrolytic solution 16 is held by the polymer compound. One reason for this is that leakage of the negative electrode aqueous electrolytic solution 16 is prevented. In FIG. 6, the electrolyte layer 22 including the negative electrode aqueous electrolytic solution 16 is darkly shaded.

The polymer compound is not particularly limited in kind, and specifically includes one or more of materials including, without limitation, polyvinylidene difluoride and polyethylene oxide.

To form the electrolyte layer 21, a precursor solution including the positive electrode aqueous electrolytic solution 15, the polymer compound, and the organic solvent is prepared, following which the precursor solution is applied on the positive electrode 13. To form the electrolyte layer 22, a precursor solution including the negative electrode aqueous electrolytic solution 16, the polymer compound, and the organic solvent is prepared, following which the precursor solution is applied on the negative electrode 14.

In this case also, the alkali metal ion is movable between the positive electrode 13 and the negative electrode 14 via the electrolyte layers 21 and 22, and similar effects are therefore achievable.

In this case, in particular, the leakage of each of the positive electrode aqueous electrolytic solution 15 and the negative electrode aqueous electrolytic solution 16 is prevented, as described above. It is therefore possible to achieve higher effects.

In FIG. 1, in the case where the positive electrode aqueous electrolytic solution 15 is contained only in a part of the positive electrode space S1, the positive electrode outlet 11PX is provided through an upper surface of the outer package member 11, and the coupling terminal part 13AT is led out from an upper side of the outer package member 11, which prevents the positive electrode sealing member 17 from being in contact with the positive electrode aqueous electrolytic solution 15. In the case where the negative electrode aqueous electrolytic solution 16 is contained only in a part of the negative electrode space S2, the negative electrode outlet 11PY is provided through the upper surface of the outer package member 11, and the coupling terminal part 14AT is led out from the upper side of the outer package member 11, which prevents the negative electrode sealing member 18 from being in contact with the negative electrode aqueous electrolytic solution 16.

However, a position at which the positive electrode outlet 11PX is provided in the outer package member 11 may be changed, and the positive electrode sealing member 17 may thus be in contact with the positive electrode aqueous electrolytic solution 15. In addition, a position at which the negative electrode outlet 11PY is provided in the outer package member 11 may be changed, and the negative electrode sealing member 18 may thus be in contact with the negative electrode aqueous electrolytic solution 16.

Specifically, as illustrated in FIG. 7 corresponding to FIG. 1, the positive electrode outlet 11PX may be provided through a side surface of the outer package member 11, and the coupling terminal part 13AT may be led out from a lateral side of the outer package member 11, which may cause the positive electrode sealing member 17 to be in contact with the positive electrode aqueous electrolytic solution 15. Further, the negative electrode outlet 11PY may be provided through a side surface of the outer package member 11, and the coupling terminal part 14AT may be led out from a lateral side of the outer package member 11, which may cause the negative electrode sealing member 18 to be in contact with the negative electrode aqueous electrolytic solution 16 (Modification example 8).

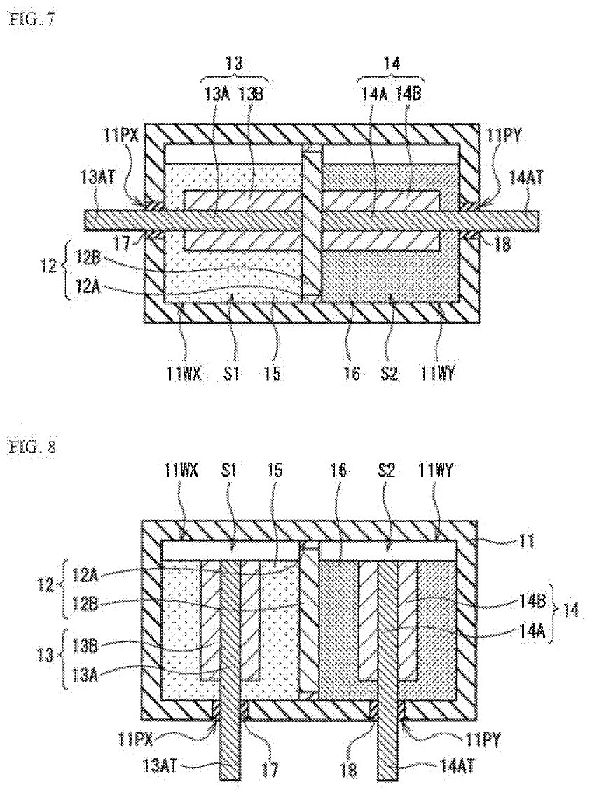

Alternatively, as illustrated in FIG. 8 corresponding to FIG. 1, the positive electrode outlet 11PX may be provided through a lower surface of the outer package member 11, and the coupling terminal part 13AT may be led out from a lower side of the outer package member 11, which may cause the positive electrode sealing member 17 to be in contact with the positive electrode aqueous electrolytic solution 15. Further, the negative electrode outlet 11PY may be provided through the lower surface of the outer package member 11, and the coupling terminal part 14AT may be led out from the lower side of the outer package member 11, which may cause the negative electrode sealing member 18 to be in contact with the negative electrode aqueous electrolytic solution 16 (Modification example 9).

In these cases also, the liquid sealing property and the gas sealing property are secured with use of the positive electrode sealing member 17 and the negative electrode sealing member 18, and similar effects are therefore achievable.

In these cases, in particular, each of the positive electrode sealing member 17 and the negative electrode sealing member 18 also exhibits waterproofness. Accordingly, the liquid sealing property and the gas sealing property are sufficiently exhibited even when the positive electrode sealing member 17 is in contact with the positive electrode aqueous electrolytic solution 15, and the liquid sealing property and the gas sealing property are also sufficiently exhibited even when the negative electrode sealing member 18 is in contact with the negative electrode aqueous electrolytic solution 16. It is therefore possible to achieve higher effects.

Applications of the secondary battery are not particularly limited as long as they are, for example, machines, equipment, instruments, apparatuses, or systems (an assembly of a plurality of pieces of equipment, for example) in which the secondary battery is usable as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. When the secondary battery is used as the auxiliary power source, the kind of the main power source is not limited to the secondary battery.

Specific examples of the applications of the secondary battery include electronic equipment (including portable electronic equipment), portable household appliances, apparatuses for data storage, electric power tools, battery packs, medical electronic equipment, electric vehicles, and electric power storage systems. Examples of the electronic equipment include video cameras, digital still cameras, mobile phones, laptop personal computers, cordless phones, headphone stereos, portable radios, portable television sets, and portable information terminals. Examples of the portable household appliances include an electric shaver. Examples of the apparatuses for data storage include backup power sources and memory cards. Examples of the electric power tools include electric drills and electric saws. The battery pack is to be mounted as detachable power sources on, for example, laptop personal computers. Examples of the medical electronic equipment include pacemakers and hearing aids. Examples of the electric vehicles include electric automobiles including hybrid automobiles. Examples of the electric power storage systems include battery systems for home use in which electric power is accumulated for an emergency. Needless to say, the secondary battery may have applications other than the series of applications described here as examples.

### EXAMPLES

A description is given of Examples of the present technology according to an embodiment.

### Examples 1 to 9 and Comparative Examples 1 and 2

Secondary batteries were fabricated, following which the secondary batteries were each evaluated for an operation characteristic, as described below.

### <Fabrication of Secondary Battery>

The secondary batteries illustrated in FIG. 5 were fabricated in accordance with the following procedure.

### <Fabrication of Positive Electrode>

First, 91 parts by mass of a positive electrode active material (LiMn₂O₄ as a lithium composite oxide), 3 parts by mass of a positive electrode binder (polyvinylidene difluoride), and 6 parts by mass of a positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on the surface of the positive electrode current collector 13A excluding the coupling terminal part 13AT using a coating apparatus, following which the applied positive electrode mixture slurry was dried to thereby form the positive electrode active material layer 13B. Used as the positive electrode current collector 13A was titanium (a titanium foil having a thickness of 20 μm) as the first metal material. Thus, the positive electrode 13 was fabricated.

### <Fabrication of Negative Electrode>

First, 89 parts by mass of a negative electrode active material (titanium dioxide of an anatase type as a titanium-containing compound (a titanium oxide)), 10 parts by mass of a negative electrode binder (polyvinylidene difluoride), and 1 part by mass of a negative electrode conductor (graphite) were mixed with each other to thereby obtain a negative electrode mixture. Thereafter, the negative electrode mixture was put into an organic solvent (N-methyl-2-pyrrolidone), following which the organic solvent was stirred to thereby prepare a negative electrode mixture slurry in paste form. Thereafter, the negative electrode mixture slurry was applied on the surface of the negative electrode current collector 14A excluding the coupling terminal part 14AT using a coating apparatus, following which the applied negative electrode mixture slurry was dried to thereby form the negative electrode active material layer 14B. Used as the negative electrode current collector 14A was titanium (a titanium foil having a thickness of 20 μm) as the second metal material. Thus, the negative electrode 14 was fabricated.

### <Preparation of Positive Electrode Aqueous Electrolytic Solution>

An ionic material (lithium sulfate (Li₂SO₄) as an electrolyte salt) was put into an aqueous solvent (pure water), following which the aqueous solvent was stirred. The positive electrode aqueous electrolytic solution 15 was thus prepared. In this case, the concentration was set to 2 mol/kg and the pH was set to 4.

### <Preparation of Negative Electrode Aqueous Electrolytic Solution>

An ionic material (lithium hydroxide (LiOH) as an electrolyte salt) was put into an aqueous solvent (pure water), following which the aqueous solvent was stirred. The negative electrode aqueous electrolytic solution 16 was thus prepared. In this case, the concentration was set to 4 mol/kg and the pH was set to 12.

### <Assembly of Secondary Battery>

First, the outer package container 11X having the opening and the outer package container 11Y having the opening were prepared.

The outer package container 11X was provided with the positive electrode outlet 11PX, and the end part 12AX was thermal-fusion-bonded to the outer package container 11X in advance. The outer package container 11Y was provided with the negative electrode outlet 11PY, and the end part 12AY was thermal-fusion-bonded to the outer package container 11Y in advance.

Used as materials (the second polymer compound) included in each of the outer package containers 11X and 11Y were polyethylene (PE), polypropylene (PP), polyethylene terephthalate (PET), polytetrafluoroethylene (PTFE), and polyvinyl chloride (PVC).

The contact angle (°) of the positive electrode aqueous electrolytic solution 15 with respect to a surface (the positive electrode inner wall surface 11WX) of the outer package container 11X and the contact angle (°) of the negative electrode aqueous electrolytic solution 16 with respect to a surface (the negative electrode inner wall surface 11WY) of the outer package container 11Y were as listed in Tables 1 to 3. Here, the material (the second polymer compound) included in the outer package container 11X and the material (the second polymer compound) included in the outer package container 11Y were the same as each other. Accordingly, the contact angle of the positive electrode aqueous electrolytic solution 15 with respect to the positive electrode inner wall surface 11WX and the contact angle of the negative electrode aqueous electrolytic solution 16 with respect to the negative electrode inner wall surface 11WY were equal to each other.

Used as materials (the first polymer compound) included in each of the end parts 12AX and 12AY were nylon (NY), polyvinyl alcohol (PVA), and ethylene-vinyl alcohol copolymer (EVOH). Used as appropriate functional groups included in the first polymer compound were a hydroxyl group (—OH) and a primary amide group (—CONHCH₃).

For comparison, polyethylene (PE) including no appropriate functional group described above was used as the material included in each of the end parts 12AX and 12AY. In Table 2, although the first polymer compound column contains polyethylene for convenience, polyethylene including no appropriate functional group does not correspond to the first polymer compound.

Thereafter, the positive electrode inner wall surface 11WX was subjected to a plasma treatment, and the negative electrode inner wall surface 11WY was also subjected to the plasma treatment, on an as-needed basis. The contact angle after the plasma treatment was as presented in Table 1.

Thereafter, the outer package containers 11X and 11Y were so disposed that the respective openings were opposed to each other, following which the outer package containers 11X and 11Y were brought close to each other until the end parts 12AX and 12AY came into contact with each other. In this case, the body part 12B was disposed between the outer package containers 11X and 11Y to thereby contain the body part 12B inside the outer package containers 11X and 11Y.

Used as the body part 12B was a cation exchange membrane (a Nafion membrane, Nafion (registered trademark) NRE212, purchased from Sigma-Aldrich Japan G.K.). A sulfonic acid ion group (—SO₃⁻) was used as a functional group included in the cation exchange membrane.

Thereafter, the end parts 12AX and 12AY were heated (at a heating temperature of 200° C.) to thereby cause the end parts 12AX and 12AY to be thermal-fusion-bonded to each other, and also cause the end parts 12AX and 12AY to be thermal-fusion-bonded to the body part 12B. As a result, the outer package containers 11X and 11Y were joined to each other with the outer edge part 12A, i.e., the end parts 12AX and 12AY, interposed therebetween. The outer package member 11 was thus formed. Further, the outer edge part 12A was, or the end parts 12AX and 12AY were, rigidly joined to the body part 12B. The partition 12 including the outer edge part 12A and the body part 12B was thus formed.

Thereafter, the positive electrode 13 was placed into the positive electrode space S1 from the positive electrode outlet 11PX, and the negative electrode 14 was placed into the negative electrode space S2 from the negative electrode outlet 11PY. In this case, the coupling terminal part 13AT was led to the outside of the outer package container 11X through the positive electrode outlet 11PX, and the coupling terminal part 14AT was led to the outside of the outer package container 11Y through the negative electrode outlet 11PY.

Thereafter, the positive electrode aqueous electrolytic solution 15 was supplied to the positive electrode space S1 through the positive electrode outlet 11PX, to thereby place the positive electrode aqueous electrolytic solution 15 in the positive electrode space S1 and immerse the positive electrode 13 in the positive electrode aqueous electrolytic solution 15.

Further, the negative electrode aqueous electrolytic solution 16 was supplied to the negative electrode space S2 through the negative electrode outlet 11PY, to thereby place the negative electrode aqueous electrolytic solution 16 in the negative electrode space S2 and immerse the negative electrode 14 in the negative electrode aqueous electrolytic solution 16.

Lastly, on an as-needed basis, the positive electrode outlet 11PX was sealed using the positive electrode sealing member 17 (an acid-modified polyolefin as the third polymer compound), and the negative electrode outlet 11PY was sealed using the negative electrode sealing member 18 (an acid-modified polyolefin as the fourth polymer compound).

In this case, the positive electrode sealing member 17 was disposed between the outer package container 11X and the coupling terminal part 13AT inside the positive electrode outlet 11PX, following which the positive electrode sealing member 17 was heated (at a heating temperature of 200° C.). Thus, the positive electrode sealing member 17 was thermal-fusion-bonded to each of the outer package container 11X and the coupling terminal part 13AT. As a result, the positive electrode outlet 11PX was hermetically closed with use of the positive electrode sealing member 17.

Further, on an as-needed basis, the negative electrode sealing member 18 was disposed between the outer package container 11Y and the coupling terminal part 14AT inside the negative electrode outlet 11PY, following which the negative electrode sealing member 18 was heated (at a heating temperature of 200° C.). Thus, the negative electrode sealing member 18 was thermal-fusion-bonded to each of the outer package container 11Y and the coupling terminal part 14AT. As a result, the negative electrode outlet 11PY was hermetically closed with use of the negative electrode sealing member 18.

Note that, when the positive electrode sealing member 17 was not included, an insulating polymer compound (a silicone resin) was used to hermetically close the positive electrode outlet 11PX, and when the negative electrode sealing member 18 was not included, an insulating polymer compound (a silicone resin) was used to hermetically close the negative electrode outlet 11PY.

Thus, the partition 12, the positive electrode 13, the negative electrode 14, the positive electrode aqueous electrolytic solution 15, and the negative electrode aqueous electrolytic solution 16 were placed inside the outer package member 11. As a result, the secondary battery was completed.

Note that a secondary battery for comparison was manufactured by a similar procedure, except that no outer edge part 12A was included. In this case, each of the outer package member 11 and the partition 12 (the body part 12B) were heated to thereby bond the partition 12 (the body part 12B) to the outer package member 11 without interposing the outer edge part 12A therebetween.

### <Evaluation of Battery Characteristic>

Evaluation of an electrolytic-solution-holding characteristic and a capacity characteristic as the operation characteristic revealed the results presented in Tables 1 to 3.

### <Electrolytic-Solution-Holding Characteristic>

To evaluate the electrolytic-solution-holding characteristic, first, a total weight (a pre-storage total weight) of the positive electrode aqueous electrolytic solution 15 and the negative electrode aqueous electrolytic solution 16 was measured in an ambient temperature environment (at a temperature of 23° C.). In this case, a weight G1 of the secondary battery during assembly before the positive electrode aqueous electrolytic solution 15 and the negative electrode aqueous electrolytic solution 16 were contained in the secondary battery was measured, and a weight G2 of the secondary battery during the assembly after the positive electrode aqueous electrolytic solution 15 and the negative electrode aqueous electrolytic solution 16 were contained in the secondary battery was measured. Thus, a pre-storage total weight was calculated by subtracting the weight G1 from the weight G2.

Thereafter, in a thermostatic chamber in a high-temperature environment (at a temperature of 50° C.), the secondary battery during assembly after the positive electrode aqueous electrolytic solution 15 and the negative electrode aqueous electrolytic solution 16 were contained in the secondary battery was stored (for a storing period of 24 hours), following which a total weight (a post-storage total weight) of the positive electrode aqueous electrolytic solution 15 and the negative electrode aqueous electrolytic solution 16 was measured. In this case, a post-storage weight G3 related to the secondary battery during the assembly after the positive electrode aqueous electrolytic solution 15 and the negative electrode aqueous electrolytic solution 16 were contained in the secondary battery was measured. Thus, a post-storage total weight was calculated by subtracting the weight G1 from the weight G3.

Thereafter, a weight reduction ratio (%) serving as an index for evaluating the electrolytic-solution-holding characteristic was calculated based on the following calculation expression: weight reduction ratio (%)=[(pre-storage total weight-post-storage total weight)/pre-storage total weight]×100.

Lastly, the weight reduction ratio was determined based on a value of the weight reduction ratio. In this case, the weight reduction ratio of less than 2% was determined as “A”, the weight reduction ratio of greater than or equal to 2% and less than 5% was determined as “B”, the weight reduction ratio of greater than or equal to 5% and less than 10% was determined as “C”, and the weight reduction ratio of greater than or equal to 10% was determined as “D”.

### <Capacity Characteristic>

To evaluate the capacity characteristic, first, the secondary battery was charged and discharged using an elecrochemical measuring device to thereby measure a discharge capacity (mAh). Thereafter, the secondary battery was disassembled to thereby take out the positive electrode active material, following which a weight (g) of the positive electrode active material was measured. Thereafter, a battery capacity (mAh/g) serving as an index for evaluating the capacity characteristic was calculated based on the following calculation expression: battery capacity (mAh/g)=discharge capacity/weight.

Lastly, the battery capacity was determined based on a value of the battery capacity. In this case, the battery capacity of greater than or equal to 80 mAh/g was determined as “A”, the battery capacity of greater than or equal to 60 mAh/g and less than 80 mAh/g was determined as “B”, the battery capacity of greater than or equal to 40 mAh/g and less than 60 mAh/g was determined as “C”, and the battery capacity of less than 40 mAh/g was determined as “D”.

TABLE 1

| | Partition | | | | | | | |
|---|---|---|---|---|---|---|---|---|
| | Body part | | Outer edge part | | Outer package member | | | |
| | Cation | | First | | Second | Contact | Weight | |
| | exchange | Functional | polymer | Functional | polymer | angle | reduction | Battery |
| | membrane | group | compound | group | compound | (°) | ratio | capacity |
| Example 1 | Nafion membrane | —SO₃⁻ | NY | —CONHCH₃ | PE | 80 | A | B |
| Example 2 | Nafion membrane | —SO₃⁻ | PVA | —OH | PE | 80 | B | B |
| Example 3 | Nafion membrane | —SO₃⁻ | EVOH | —OH | PE | 80 | A | B |
| Example 4 | Nafion membrane | —SO₃⁻ | NY | —CONHCH₃ | PP | 90 | A | C |
| Example 5 | Nafion membrane | —SO₃⁻ | NY | —CONHCH₃ | PET | 60 | B | A |
| Example 6 | Nafion membrane | —SO₃⁻ | NY | —CONHCH₃ | PTFE | 150 | C | C |
| Example 7 | Nafion membrane | —SO₃⁻ | NY | —CONHCH₃ | PVC | 80 | A | B |
| Example 8 | Nafion membrane | —SO₃⁻ | NY | —CONHCH₃ | PE | 40 | A | A |
| | | | | | (plasma | | | |
| | | | | | treatment) | | | |

Positive electrode current collector (first metal material): titanium foil (titanium), Negative electrode current collector (second metal material): titanium foil (titanium)
Positive electrode sealing member: acid-modified polyolefin, Negative electrode sealing member: acid-modified polyolefin
Positive electrode aqueous electrolytic solution: Li₂SO₄ (pH = 4), Negative electrode aqueous electrolytic solution: LiOH (pH = 12)

TABLE 2

| | Partition | | | | | | | |
|---|---|---|---|---|---|---|---|---|
| | Body part | | Outer edge part | | Outer package member | | | |
| | Cation | | First | | Second | Contact | Weight | |
| | exchange | Functional | polymer | Functional | polymer | angle | reduction | Battery |
| | membrane | group | compound | group | compound | (°) | ratio | capacity |
| Comparative | Nafion | —SO₃⁻ | — | — | PE | 80 | D | D |
| example 1 | membrane | | | | | | | |
| Comparative | Nafion | —SO₃⁻ | PE | — | PP | 90 | D | D |
| example 2 | membrane | | | | | | | |

Positive electrode current collector (first metal material): titanium foil (titanium), Negative electrode current collector (second metal material): titanium foil (titanium)
Positive electrode sealing member: acid-modified polyolefin, Negative electrode sealing member: acid-modified polyolefin
Positive electrode aqueous electrolytic solution: Li₂SO₄ (pH = 4), Negative electrode aqueous electrolytic solution: LiOH (pH = 12)

TABLE 3

| | | | | | Positive | Negative | | |
|---|---|---|---|---|---|---|---|---|
| | | | | | electrode | electrode | | |
| | Partition | | | | sealing | sealing | | |
| | Body part | | Outer edge part | | member | member | | |
| | Cation | | First | | Third | Fourth | Weight | |
| | exchange | Functional | polymer | Functional | polymer | polymer | reduction | Battery |
| | membrane | group | compound | group | compound | compound | ratio | capacity |
| Example 1 | Nafion | —SO₃⁻ | NY | —CONHCH₃ | Acid-modified | Acid-modified | A | B |
| | membrane | | | | polyolefin | polyolefin | | |
| Example 9 | Nafion | —SO₃⁻ | NY | —CONHCH₃ | — | — | C | C |
| | membrane | | | | | | | |

Positive electrode current collector (first metal material): titanium foil (titanium), Negative electrode current collector (second metal material): titanium foil (titanium)
Positive electrode aqueous electrolytic solution: Li₂SO₄ (pH = 4), Negative electrode aqueous electrolytic solution: LiOH (pH = 12)
Outer package member (second polymer compound): PE, Contact angle: 80°

As indicated in Tables 1 to 3, the weight reduction ratio and the battery capacity each varied depending on the configuration of the secondary battery.

Specifically, when the partition 12 included only the body part 12B and when the partition 12 included the outer edge part 12A but the outer edge part 12A included no appropriate functional group (Comparative examples 1 and 2), a volatilization amount of each of the positive electrode aqueous electrolytic solution 15 and the negative electrode aqueous electrolytic solution 16 increased. This resulted in an increase in the weight reduction ratio. The charging and discharging reactions using the partition 12 also did not proceed sufficiently. This resulted in a decrease in the battery capacity. In this case, in particular, the positive electrode aqueous electrolytic solution 15 and the negative electrode aqueous electrolytic solution 16 were mixed with each other. Therefore, the secondary battery did not substantially undergo charging and discharging.

In contrast, when the secondary battery included not only the body part 12B but also the outer edge part 12A, and the outer edge part 12A included the appropriate functional group (Examples 1 to 9), the volatilization amount of each of the positive electrode aqueous electrolytic solution 15 and the negative electrode aqueous electrolytic solution 16 decreased. This resulted in a decrease in the weight reduction ratio. The charging and discharging reactions using the partition 12 also proceeded sufficiently. This resulted in an increase in the battery capacity. In this case, in particular, the positive electrode aqueous electrolytic solution 15 and the negative electrode aqueous electrolytic solution 16 did not mix with each other. Therefore, the secondary battery underwent charging and discharging stably.

That is, when the body part 12B included the cation exchange membrane and the outer edge part 12A (the first polymer compound) included the appropriate functional group, i.e., the hydroxyl group or the primary amide group, favorable results were obtained in both the weight reduction ratio and the battery capacity.

In this case, in particular, a series of the tendencies described below was obtained.

First, when the first polymer compound included either the primary amide group or the hydroxyl group, the weight reduction ratio sufficiently decreased and the battery capacity sufficiently increased. Specific experimental results were not presented here; however, similar tendencies were also obtained when the first polymer compound included any one of the primary amino group, the secondary amino group, the secondary amide group, or the carboxyl group.

Second, when the first polymer compound included any one of nylon, polyvinyl alcohol, or the ethylene-vinyl alcohol copolymer, the weight reduction ratio sufficiently decreased and the battery capacity sufficiently increased.

Third, when the cation exchange membrane included the sulfonic acid ion group, the weight reduction ratio sufficiently decreased and the battery capacity sufficiently increased. Specific experimental results were not presented here; however, similar tendencies were also obtained when the cation exchange membrane included the carboxylic acid ion group.

Fourth, when the second polymer compound included any one of polyethylene, polypropylene, polyethylene terephthalate, polytetrafluoroethylene, or polyvinyl chloride, the weight reduction ratio sufficiently decreased and the battery capacity sufficiently increased.

Fifth, when the outer edge part 12A and the body part 12B were thermal-fusion-bonded to each other, the weight reduction ratio sufficiently decreased and the battery capacity sufficiently increased.

Sixth, when the positive electrode outlet 11PX was sealed using the positive electrode sealing member 17 (the third polymer compound) and the negative electrode outlet 11PY was sealed using the negative electrode sealing member 18 (the fourth polymer compound), the weight reduction ratio further decreased and the battery capacity further increased.

Seventh, when the contact angle of the positive electrode aqueous electrolytic solution 15 with respect to the positive electrode inner wall surface 11WX was less than or equal to 150° and the contact angle of the negative electrode aqueous electrolytic solution 16 with respect to the negative electrode inner wall surface 11WY was less than or equal to 150°, the battery capacity further increased.

Eighth, when the pH of the negative electrode aqueous electrolytic solution 16 was higher than the pH of the positive electrode aqueous electrolytic solution 15, the battery capacity sufficiently increased. In this case, a high battery capacity was achieved when the pH of the negative electrode aqueous electrolytic solution 16 was higher than or equal to 11 and the pH of the positive electrode aqueous electrolytic solution 15 was within the range from 3 to 8 both inclusive.

Based on the results indicated in Tables 1 to 3, the weight reduction ratio decreased and the battery capacity increased when: the partition 12 included the outer edge part 12A and the body part 12B; the body part 12B included the cation exchange membrane; the outer edge part 12A included the first polymer compound; and the first polymer compound included any one or more of the hydroxyl group, the primary amino group, the secondary amino group, the primary amide group, the secondary amide group, or the carboxyl group. Accordingly, the electrolytic-solution-holding characteristic and the capacity characteristic were both improved, and a superior operation characteristic was thus achieved.

Although the configuration of the secondary battery of the present technology has been described above with reference to one or more embodiments including Examples, the configuration of the secondary battery of the present technology is not limited thereto, and is therefore modifiable in a variety of ways.

The effects described herein are mere examples, and effects of the present technology are therefore not limited to those described herein. Accordingly, the present technology may achieve any other effect.

Note that the present technology may have any of the following configurations according to an embodiment.

<1>

A secondary battery including:
a partition that allows an alkali metal ion to pass through the partition;
an outer package member having a positive electrode space and a negative electrode space inside the outer package member, the positive electrode space and the negative electrode space being separated from each other with the partition interposed between the positive electrode space and the negative electrode space;
a positive electrode aqueous electrolytic solution contained in the positive electrode space;
a negative electrode aqueous electrolytic solution contained in the negative electrode space;
a positive electrode that is immersed in the positive electrode aqueous electrolytic solution and which the alkali metal ion is to be inserted into and extracted from; and
a negative electrode that is immersed in the negative electrode aqueous electrolytic solution and which the alkali metal ion is to be inserted into and extracted from, in which
the partition includes
   an outer edge part that is adjacent to the outer package member, and
   a body part positioned on an inner side relative to the outer edge part, the body part includes a cation exchange membrane,
the cation exchange membrane includes a sulfonic acid ion group, a carboxylic acid ion group, or both,
all or a part of the outer edge part includes a first polymer compound, and
the first polymer compound includes at least one of a hydroxyl group, a carboxyl group, a carboxylic acid anhydride, a carboxylic acid ester, or a basic functional group including nitrogen.
   <2>

The secondary battery according to <1>, in which the first polymer compound includes at least one of the hydroxyl group, a primary amino group, a secondary amino group, a primary amide group, a secondary amide group, or the carboxyl group.

<3>

The secondary battery according to <1> or <2>, in which all of the outer edge part includes the first polymer compound.

<4>

The secondary battery according to any one of <1> to <3>, in which the outer edge part and the body part are integrated with each other.

<5>

The secondary battery according to any one of <1> to <4>, in which the body part is positioned on the inner side relative to the outer edge part inside the outer package member, and is unexposed to an outside of the outer package member.

<6>

The secondary battery according to any one of <1> to <5>, in which the cation exchange membrane includes a sulfonic acid ion group, a carboxylic acid ion group, or both.

<7>

The secondary battery according to any one of <1> to <6>, in which the first polymer compound includes at least one of nylon, polyvinyl alcohol, or an ethylene-vinyl alcohol copolymer.

<8>

The secondary battery according to any one of <1> to <7>, in which
the outer package member includes a second polymer compound, and
the second polymer compound includes at least one of polyethylene, polypropylene, polyethylene terephthalate, polytetrafluoroethylene, or polyvinyl chloride.
   <9>

The secondary battery according to any one of <1> to <8>, in which
the outer package member includes a positive electrode outlet that communicates with the positive electrode space,
the positive electrode includes a positive electrode current collector,
the positive electrode current collector is led to an outside of the outer package member through the positive electrode outlet,
the secondary battery further includes a positive electrode sealing member that is disposed between the outer package member and the positive electrode current collector inside the positive electrode outlet, and that is adjacent to each of the outer package member and the positive electrode current collector,
the positive electrode current collector includes a first metal material,
the first metal material includes at least one selected from the group of titanium, aluminum, nickel, and alloys of two or more of titanium, aluminum, and nickel,
the positive electrode sealing member includes a third polymer compound, and
the third polymer compound includes an acid-modified polyolefin.
   <10>

The secondary battery according to any one of <1> to <9>, in which
the outer package member includes a negative electrode outlet that communicates with the negative electrode space,
the negative electrode includes a negative electrode current collector,
the negative electrode current collector is led to an outside of the outer package member through the negative electrode outlet,
the secondary battery further includes a negative electrode sealing member that is disposed between the outer package member and the negative electrode current collector inside the negative electrode outlet, and that is adjacent to each of the outer package member and the negative electrode current collector,
the negative electrode current collector includes a second metal material,
the second metal material includes at least one selected from the group of stainless steel, titanium, zinc, tin, lead, and alloys of two or more of stainless steel, titanium, zinc, tin, and lead,
the negative electrode sealing member includes a fourth polymer compound, and the fourth polymer compound includes an acid-modified polyolefin.
   <11>

The secondary battery according to any one of <1> to <10>, in which
the outer package member includes a positive electrode inner wall surface that is in contact with the positive electrode aqueous electrolytic solution inside the positive electrode space, and
a contact angle of the positive electrode aqueous electrolytic solution with respect to the positive electrode inner wall surface is less than or equal to 150 degrees.
   <12>

The secondary battery according to any one of <1> to <11>, in which
the outer package member includes a negative electrode inner wall surface that is in contact with the negative electrode aqueous electrolytic solution inside the negative electrode space, and
a contact angle of the negative electrode aqueous electrolytic solution with respect to the negative electrode inner wall surface is less than or equal to 150 degrees.
   <13>

The secondary battery according to any one of <1> to <12>, in which the negative electrode aqueous electrolytic solution has a pH that is higher than a pH of the positive electrode aqueous electrolytic solution.

<14>

The secondary battery according to <13>, in which
the pH of the negative electrode aqueous electrolytic solution is higher than or equal to 11, and
the pH of the positive electrode aqueous electrolytic solution is higher than or equal to 3 and lower than or equal to 8.
   <15>

A method of manufacturing a secondary battery, the method including, in a process of manufacturing the secondary battery according to any one of <1> to <14>:
thermal-fusion-bonding all or a part of the outer edge part and the body part to each other; and
forming the partition by the thermal-fusion-bonding.

### REFERENCE SIGNS LIST

11 Outer package member
11PX Positive electrode outlet
11PY Negative electrode outlet
11WX Positive electrode inner wall surface
11WY Negative electrode inner wall surface
12 Partition
12A Outer edge part
12B Body part
13 Positive electrode
13A Positive electrode current collector
14 Negative electrode
14A Negative electrode current collector
15 Positive electrode aqueous electrolytic solution
16 Negative electrode aqueous electrolytic solution
17 Positive electrode sealing member
18 Negative electrode sealing member
S1 Positive electrode space
S2 Negative electrode space

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a partition that allows an alkali metal ion to pass through the partition;
an outer package member having a positive electrode space and a negative electrode space inside the outer package member, the positive electrode space and the negative electrode space being separated from each other with the partition interposed between the positive electrode space and the negative electrode space;
a positive electrode aqueous electrolytic solution contained in the positive electrode space;
a negative electrode aqueous electrolytic solution contained in the negative electrode space;
a positive electrode that is immersed in the positive electrode aqueous electrolytic solution and which the alkali metal ion is to be inserted into and extracted from; and
a negative electrode that is immersed in the negative electrode aqueous electrolytic solution and which the alkali metal ion is to be inserted into and extracted from, wherein
the partition includes
an outer edge part that is adjacent to the outer package member, and
a body part positioned on an inner side relative to the outer edge part,
the body part includes a cation exchange membrane,
all or a part of the outer edge part includes a first polymer compound, and
the first polymer compound includes at least one of a hydroxyl group, a carboxyl group, a carboxylic acid anhydride, a carboxylic acid ester, or a basic functional group including nitrogen.

2. The secondary battery according to claim 1, wherein the first polymer compound includes at least one of the hydroxyl group, a primary amino group, a secondary amino group, a primary amide group, a secondary amide group, or the carboxyl group.

3. The secondary battery according to claim 1, wherein all of the outer edge part includes the first polymer compound.

4. The secondary battery according to claim 1, wherein the outer edge part and the body part are integrated with each other.

5. The secondary battery according to claim 1, wherein the body part is positioned on the inner side relative to the outer edge part inside the outer package member, and is unexposed to an outside of the outer package member.

6. The secondary battery according to claim 1, wherein the cation exchange membrane includes a sulfonic acid ion group, a carboxylic acid ion group, or both.

7. The secondary battery according to claim 1, wherein the first polymer compound includes at least one of nylon, polyvinyl alcohol, or an ethylene-vinyl alcohol copolymer.

8. The secondary battery according to claim 1, wherein
the outer package member includes a second polymer compound, and
the second polymer compound includes at least one of polyethylene, polypropylene, polyethylene terephthalate, polytetrafluoroethylene, or polyvinyl chloride.

9. The secondary battery according to claim 1, wherein
the outer package member includes a positive electrode outlet that communicates with the positive electrode space,
the positive electrode includes a positive electrode current collector,
the positive electrode current collector is led to an outside of the outer package member through the positive electrode outlet,
the secondary battery further comprises a positive electrode sealing member that is disposed between the outer package member and the positive electrode current collector inside the positive electrode outlet, and that is adjacent to each of the outer package member and the positive electrode current collector,
the positive electrode current collector includes a first metal material,
the first metal material includes at least one selected from the group of titanium, aluminum, nickel, and alloys of two or more of titanium, aluminum, and nickel,
the positive electrode sealing member includes a third polymer compound, and
the third polymer compound includes an acid-modified polyolefin.

10. The secondary battery according to claim 1, wherein
the outer package member includes a negative electrode outlet that communicates with the negative electrode space,
the negative electrode includes a negative electrode current collector,
the negative electrode current collector is led to an outside of the outer package member through the negative electrode outlet,
the secondary battery further comprises a negative electrode sealing member that is disposed between the outer package member and the negative electrode current collector inside the negative electrode outlet, and that is adjacent to each of the outer package member and the negative electrode current collector,
the negative electrode current collector includes a second metal material,
the second metal material includes at least one selected from the group of stainless steel, titanium, zinc, tin, lead, and alloys of two or more of stainless steel, titanium, zinc, tin, and lead,
the negative electrode sealing member includes a fourth polymer compound, and
the fourth polymer compound includes an acid-modified polyolefin.

11. The secondary battery according to claim 1, wherein
the outer package member includes a positive electrode inner wall surface that is in contact with the positive electrode aqueous electrolytic solution inside the positive electrode space, and
a contact angle of the positive electrode aqueous electrolytic solution with respect to the positive electrode inner wall surface is less than or equal to 150 degrees.

12. The secondary battery according to claim 1, wherein
the outer package member includes a negative electrode inner wall surface that is in contact with the negative electrode aqueous electrolytic solution inside the negative electrode space, and
a contact angle of the negative electrode aqueous electrolytic solution with respect to the negative electrode inner wall surface is less than or equal to 150 degrees.

13. The secondary battery according to claim 1, wherein the negative electrode aqueous electrolytic solution has a pH that is higher than a pH of the positive electrode aqueous electrolytic solution.

14. The secondary battery according to claim 13, wherein
the pH of the negative electrode aqueous electrolytic solution is higher than or equal to 11, and
the pH of the positive electrode aqueous electrolytic solution is higher than or equal to 3 and lower than or equal to 8.

15. A method of manufacturing a secondary battery, the method comprising, in a process of manufacturing the secondary battery according to claim 1:
thermal-fusion-bonding all or a part of the outer edge part and the body part to each other; and
forming the partition by the thermal-fusion-bonding.
